(19) United States
(12) Patent Application Publication
(10) Pub. No.: US 2009/0120263 A1
(43) Pub. Date: May 14, 2009

(54) SCORER APPARATUS FOR CORRUGATED PAPERBOARD SHEET

(75) Inventors: Michio Suzuki, Kasugai-shi (JP); Hiroki Momonaka, Kasugai-shi (JP)

Correspondence Address: STROOCK & STROOCK & LAVAN LLP, 180 MAIDEN LANE, NEW YORK, NY, 10038, US

(73) Assignee: Kabushiki kaisha Isowa, Nagoya-shi (JP)

(21) Appl. No.: 12/268,098

(22) Filed: Nov. 10, 2008

(30) Foreign Application Priority Data
Nov. 12, 2007 (JP) 2007-293201

(51) Int. Cl. B26D 11/00; B26D 3/08; B26D 5/00

(52) U.S. Cl. 83/865; 83/883; 83/73

(57) ABSTRACT

Disclosed is a scorer apparatus for scoring a surface of a corrugated paperboard sheet (DS) being continuously fed along a feed line. The scorer apparatus comprises a plurality of scorers each adapted to be displaced to a given position in a crosswise direction of a corrugated paperboard sheet, and made up of a pair of upper and lower segments (10, 12) at least one of which is adapted to be displaced in a vertical direction during the scoring, and displacement-amount control means operable to control respective vertical displacement amounts of the scorers individually on a scorer-by-scorer basis during the scoring. The scorer apparatus of the present invention can adequately form a plurality of score lines in one lot and through a single-step scoring process.

### BACKGROUND OF THE INVENTION

1. Field of the Invention

The present invention relates to a scorer apparatus for corrugated paperboard, and more specifically to a scorer apparatus for scoring a surface of a corrugated paperboard sheet being continuously fed along a feed line.

2. Description of the Related Art

Heretofore, there has been known a slitter-scorer apparatus as disclosed in JP 2004-243643A (U.S. Pat. No. 7,370,562). This type of slitter-scorer apparatus is intended to deal with a large-lot order.

The above type of slitter-scorer apparatus is used, particularly in Japan, in a dry end of a corrugator machine, which is designed such that a corrugated paperboard sheet is fed from a slitter-scorer apparatus to a “single” cutter, i.e., a single-tiered cutter, and then fed to a defective removing unit, as disclosed in JP 2002-036171A and U.S. Pat. No. 5,918,519. In the single cutter, the corrugated paperboard sheet scored and slit by the slitter-scorer apparatus is cut along a direction perpendicular to a feed direction of the corrugated paperboard sheet by a single cutter unit.

The above type of slitter-scorer apparatus is also used, particularly in US, in a dry end of a corrugator machine, which is designed such that a corrugated paperboard sheet is fed from a slitter-scorer apparatus to a “double” cutter, i.e., a two-tiered cutter, and then fed to a defective removing unit, as disclosed in JP 2000-135696A (U.S. Pat. No. 6,568,304). In the double cutter, the corrugated paperboard sheet scored and slit by the slitter-scorer apparatus is divided along a dividing slit into right and left portions with respect to a feed direction of the corrugated paperboard sheet. The divided corrugated paperboard sheet portions are fed while being separated from each other one above the other, and cut along a direction perpendicular to the feed direction by an upper cutter and a lower cutter, respectively.

As a common practice in the corrugated paperboard container manufacturing industry, the conventional slitter-scorer apparatus as disclosed in the JP 2004-243643A (U.S. Pat. No. 7,370,562) has been designed to set one common value as a displacement amount of each of a plurality of scorers for forming a plurality of score lines. Thus, in a process of forming plural types of score lines in a corrugated paperboard sheet of the same lot under different scoring pressures or different scoring modes, it is necessary for the corrugated paperboard sheet to undergo a plurality of scoring steps. Specifically, a corrugated paperboard sheet of a certain lot is subjected to a first scoring step under a condition that a vertical displacement amount (or an inter-roll gap value) of a specific one of a plurality of (e.g., three) scorers is set to a first value for obtaining a certain level of scoring pressure. Then, the corrugated paperboard sheet of the same lot is subjected to a second scoring step and further to a third scoring step, under a condition that a vertical displacement (or an inter-roll gap value) of a specific one of the remaining scorers is set to a different value from the first value. In the conventional slitter-scorer apparatus, such a multi-step scoring process is primarily performed for a large-lot order (a length of one lot is relatively long). Thus, a time required for setting the vertical displacement amount of the scorer in the second and third scoring steps does not have a significant negative impact on productivity, because a ratio of the setup time to a total time of the scoring process is relatively low.

Recent years, in the entire industries, the trend toward high-mix low-volume production has become stronger. In connection with such high-mix low-volume products, there has been an increasing need for high-mix low-volume production of corrugated paperboard products. That is, there is a need for producing corrugated paperboard products in response to a small-lot order (e.g., about 10 m).

In the high-mix low-volume production of corrugated paperboard products, if the multi-step scoring process is performed in the above manner to form plural types of score lines in a corrugated paperboard sheet of a certain lot under different scoring pressures or different scoring modes (point-to-point mode, offset mode, 3-point mode, etc.), the ratio of the setup time for the second and third scoring steps becomes higher to cause deterioration in productivity of corrugated paperboard products.

In addition to the need for high-mix low-volume production of corrugated paperboard products, there has also been an increasing need for enhancing assemblability of a corrugated paperboard product and appearance of a print on a corrugated paperboard product.

The inventor of this application found that the assemblability of a corrugated paperboard product can be effectively enhanced by forming plural types of score lines in a corrugated paperboard sheet of a certain lot under different scoring pressures or different scoring modes so as to specify a sequence or direction of bending or folding of the corrugated paperboard product, and appearance of a print on a corrugated paperboard product can be effectively enhanced by forming a score line in a printing area of a corrugated paperboard sheet of a certain lot under a relatively low scoring pressure.

As in the apparatus disclosed in the JP 2004-243643A (U.S. Pat. No. 7,370,562), it has not been conventionally implemented to form plural types of score lines under different scoring pressures or different scoring modes through a single-step scoring process (i.e., a single cycle of scoring process). Specifically, a scorer (or slitter-scorer) control section in the conventional apparatus is not designed to carry out such a function by itself, particularly, under a condition that a corrugated paperboard sheet is fed at a high speed. Therefore, the multi-step scoring process is essential for the conventional apparatus to enhance assemblability and print appearance, which leads to deterioration in productivity.

On the other hand, the conventional apparatus as disclosed in the JP 2004-243643A (U.S. Pat. No. 7,370,562) has an advantage of being easy to compute a time required for displacing the scorers to a position corresponding to a next order, and to cut off and remove a certain length of defective-length portion depending on the displacement time, because the vertical displacement amount of each of the plurality of scorers or a plurality of slitters is set at a common value.

In contrast, the technique of forming plural types of score lines under different scoring pressures or different scoring modes through a single-step scoring process will pose a dilemma that, while respective vertical displacement amounts of the plurality of scorers can be set at different values, it becomes difficult to accurately figure out a defective length.

### SUMMARY OF THE INVENTION

It is therefore an object of the present invention to provide a scorer apparatus for a corrugated paperboard sheet, which is capable of obtaining a plurality of desired score lines in one lot and through a single-step scoring process.

In order to achieve the above object, according one aspect of the present invention, there is provided a slitter-scorer apparatus provided in a feed line of a corrugated paperboard sheet, in a dry end of a corrugator machine, which comprises: a slitter for slitting the corrugated paperboard sheet along a feed direction of the corrugated paperboard sheet; a plurality of scorers for scoring the corrugated paperboard sheet along the feed direction, wherein each of the scorers is adapted to be displaced in a crosswise direction perpendicular to the feed direction and to a given position of the corrugated paperboard sheet, and made up of a pair of upper and lower segments at least one of which is adapted to be displaced in a vertical direction to adjust a gap therebetween, during the scoring; scorer control means operable to control the crosswise and/or vertical displacements of each of the scorers; and displacement-amount control means operable, based on given order information, to provide information to the scorer control means in such a manner as to allow the scorer control means to control respective vertical displacement amounts of the scorers individually on a scorer-by-scorer basis during the scoring.

In the slitter-scorer apparatus of the present invention, score lines are formed under a condition that the respective vertical displacement amounts of the scorers are controlled individually on a scorer-by-scorer basis. This makes it possible to obtain a plurality of desired score lines in one lot and through a single-step scoring process. That is, in an operation of forming a plurality of score lines different in depth or size, and configuration, such score lines can be obtained in one lot and through a single-step scoring process with enhanced production efficiency even in a small-lot order. In addition, the slitter for slitting the corrugated paperboard sheet along the feed direction is used in combination with the above scorers in the corrugator machine. This makes it possible to produce corrugated paperboard products having various sizes or configurations.

Preferably, in the slitter-scorer apparatus of the present invention, the displacement amount control means is operable to control the respective vertical displacement amounts of the scorers individually in such a manner as to allow respective scoring pressures of the scorers to become different from each other.

According to the present invention described above, the respective vertical displacement amounts of the scorers are controlled individually to allow the respective scoring pressures of the scorers to become different from each other. Thus, for example, a plurality of point-to-point type scorers may be used for simultaneously forming plural types of score lines different in depth and size.

Preferably, in the above slitter-scorer apparatus, the displacement amount control means is operable to control the respective vertical displacement amounts of the scorers in such a manner that at least two or more of the scorers have different scoring pressures which allow respective score lines formed by the at least two or more scorers to be different in foldability.

According to the present invention described above, the respective vertical displacement amounts of the scorers are controlled in such a manner that at least two or more of the scorers have different scoring pressures which allow respective score lines formed by the at least two or more scorers to be different in foldability. This can contribute to improvement in assemblability of a corrugated paperboard product.

Preferably, in the above slitter-scorer apparatus, the displacement amount control means is operable to control the respective vertical displacement amounts of the scorers in such a manner that any one or more of the scorers each arranged to form a score line in a printing area of the corrugated paperboard sheet have a scoring pressure set to be less than that for the remaining scorers so as to prevent the score line from causing print fading.

According to the present invention described above, the respective vertical displacement amounts of the scorers are controlled in such a manner that any one or more of the scorers each arranged to form a score line in a printing area of the corrugated paperboard sheet have a scoring pressure set to be less than that for the remaining scorers so as to prevent the score line from causing print fading. This can contribute to improvement in appearance of a print on a corrugated paperboard product.

Preferably, in the above slitter-scorer apparatus, the scorers include at least two scorers each having a pair of protrusions which are arranged to protrude respectively in a downward direction and in an upward direction, and adapted to be located in opposed relation to each other at a common position, and the displacement amount control means is operable to control respective vertical displacement amounts of the at least two scorers in such a manner that respective scoring pressures to be generates by the at least two pairs of protrusions of the at least two scorers become different from each other.

According to the present invention described above, different score lines can be simultaneously formed based on the pair of protrusions located in opposed relation to each other at the common position, for example, in a point-to-point mode.

Preferably, in the slitter-scorer apparatus of the present invention, the displacement amount control means is operable to controllably allow the respective vertical displacement amounts of the scorers to become different from each other, depending on a configuration of a score line to be formed by each of the scorers, i.e., a scoring mode of each of the scorers.

According to the present invention described above, the respective vertical displacement amounts of the scorers are controllably allowed to become different from each other, depending on a scoring mode of each of the scorers. Thus, for example, a plurality of offset-type scorers or three-point type scorers may be used for simultaneously forming plural types of score lines different in configuration.

Preferably, in the above slitter-scorer apparatus, the displacement amount control means is operable to control the respective vertical displacement amounts of the scorers in such a manner that respective score lines formed by at least two or more of the scorers have configurations different in folding direction and/or size.

According to the present invention described above, the respective vertical displacement amounts of the scorers are controlled in such a manner that respective score lines formed by at least two or more of the scorers have configurations different in folding direction and/or size. This can contribute to improvement in assemblability of a corrugated paperboard product.

Preferably, in the above slitter-scorer apparatus, the pair of upper and lower segments in at least one of the scorers have respective ones of a pair of protrusions which are arranged to protrude respectively in a downward direction and in an upward direction, and adapted to be positionally adjusted in the crosswise direction so as to be located in opposed relation to each other, at a common position, and the pair of upper and lower segments in at least one of the remaining scorers have respective ones of a pair of protrusions which are arranged to protrude respectively in the downward direction and in the upward direction, and adapted to be positionally adjusted in the crosswise direction in such a manner that the protrusion of one of the upper and lower segments and a planar portion of the other segment are located in opposed relation to each other at mutually offset positions, wherein at least one of the configurations of foldable score lines is obtained by the scoring based on the pair of protrusions located at the mutually offset positions.

According to the present invention described above, a score line based on a scorer having the pair of protrusions protruding respectively in the downward and upward directions in an offset arrangement, and other type of score line (based on a point-to-point type scorer, a three-point type scorer or other offset type scorer), can be simultaneously formed.

Preferably, in the above slitter-scorer apparatus, the displacement amount control means is operable to control respective vertical displacement amounts of the at least two scorers in such a manner that the vertical displacement amount of the at least one scorer having the pair of protrusions located in opposed relation to each other at the common position becomes greater than that of the at least one scorer having the pair of protrusions located at the mutually offset positions, whereby a concave portion defining a folding direction is formed in each of front and rear surfaces of the corrugated paperboard sheet through the scoring based on the pair of protrusions located in the opposed relation to each other at the common position, and a bent portion is formed in the corrugated paperboard sheet through the scoring based on the pair of protrusions located at the mutually offset positions.

According to the present invention described above, plural types of score lines different in configuration can be simultaneously formed based on the scorer having the pair of protrusions protruding respectively in the downward and upward directions in an offset arrangement, and the point-to-point type scorer.

Preferably, in the above slitter-scorer apparatus, the displacement amount control means is operable to control the respective vertical displacement amounts of the at least two scorers in such a manner that the vertical displacement amount of the at least one scorer having the pair of protrusions located in opposed relation to each other at the common position becomes greater than that of the at least one scorer having the pair of protrusions located at the mutually offset positions, whereby a concave portion is formed in each of front and rear surfaces of the corrugated paperboard sheet through the scoring based on the pair of protrusions located in opposed relation to each other at the common position, and a bent portion is formed in the corrugated paperboard sheet through the scoring based on the pair of protrusions located at the mutually offset positions, in such a manner that a size of the bent portion becomes greater than that of the concave portion.

According to the present invention described above, plural types of score lines different in configuration and size can be simultaneously formed based on the scorer having the pair of protrusions protruding respectively in the downward and upward directions in an offset arrangement, and the point-to-point type scorer.

Preferably, in the above slitter-scorer apparatus, the pair of upper and lower segments in at least one of the scorers have a protrusion and a recess, respectively, wherein a foldable score line is formed in a configuration which protrudes upwardly or downwardly, by the protrusion and the recess.

According to the present invention described above, an upwardly or downwardly protruding score line based on the three-point type scorer having the protrusion and recess, and other type of score line (based on a point-to-point type scorer, an offset-type scorer or other three-point type scorer), can be simultaneously formed.

Preferably, in the slitter-scorer apparatus of the present invention, the displacement amount control means is operable to compute the respective vertical displacement amount of the scorers using a computing device, and each of the scorers is adapted to be displaced based on a servomotor according to a signal from the computing device.

According to the present invention described above, a plurality of desired score lines can be obtained in one lot and through a single-step scoring process by effectively utilizing a conventional device.

Preferably, the slitter-scorer apparatus of the present invention comprises a management section operable, based on the given order information, to provide to the scorer control means information about computational processing for the scoring of the corrugated paperboard sheet, wherein the scorer control means includes computing means operable to compute a defective length from a longest one of respective displacement times of the scorers in the vertical direction and the crosswise direction, and the management section includes defective-length cutting means operable to instruct a cutter adapted to cut the corrugated paperboard sheet into a plurality of pieces each having a given length, to cut off and remove a defective-length portion of the corrugated paperboard sheet based on the computed defective length.

According to the present invention described above, a displacement time of each of the scorers required for reaching a position corresponding to a next order can be adequately computed by the computing means in the scorer control means, and a defective-length portion can be adequately cut off and removed depending on the displacement times from the management section. This makes it possible to share the two roles between a scorer control section (i.e., scorer control means) and the management section to achieve a function of forming plural types of score lines in one lot, which was conventionally unachievable.

Preferably, in the slitter-scorer apparatus of the present invention, the given order information includes production order data which orders a scoring pressure of each of the scorers and a type of score line, based on any one or a combination of two or more of a flute and a paper quality of the corrugated paperboard sheet, and an area and a quality of a print to be applied to a corrugated paperboard sheet product in a carton forming process, and the displacement amount control means is operable to receive the production order data from an external computer connected to the management section, and control the respective vertical displacement amounts of the scorers based on the received production order data.

According to the present invention described above, a function of forming plural types of score lines in one lot effectively and accurately, which was conventionally unachievable, can be achieved by utilizing a computer system including a database. In this case, a scoring displacement amount between two orders is fundamentally set based on a value which is entered into a given external computer in advance by a user depending on a type of flute (thickness of a target corrugated paperboard sheet), etc. The management section can receive such production order data including data about a carton forming process, from the external computer, so that the adjustment can be performed while additionally taking account of conditions (print, etc) of a final product to be produced through the subsequent carton forming process.

Preferably, the slitter-scorer apparatus of the present invention, the feed line of the corrugated paperboard sheet in the dry end of the corrugator machine is provided with a cutter for cutting the corrugated paperboard sheet along the crosswise direction, wherein the cutter consists of a single cutter which is provided in a number of one to the feed line, wherein the corrugated paperboard sheet after being slit and scored by the slitter and the scorers is entirely fed to the single cutter.

According to the present invention described above, the corrugated paperboard sheet after being slit and scored by the slitter and the scorers is entirely fed to the single cutter. This makes it possible to efficiently produce a corrugated paperboard product. Further, in cases where only an unnecessary portion of the corrugated paperboard sheet is removed by the slitter without slitting (dividing) the remaining portion of the corrugated paperboard sheet, a single corrugated paperboard sheet having a wide width in the crosswise direction can be produced.

Preferably, in the above slitter-scorer apparatus, the slitter is adapted to slit the corrugated paperboard sheet along the feed direction so as to form at least two corrugated paperboard sheet portions arranged in the crosswise direction, and each of the scorers is adapted to score the at least two corrugated paperboard sheet portions. Further, the single cutter is adapted to simultaneously cut the at least two corrugated paperboard sheet portions after being scored.

According to the present invention described above, two or more corrugated paperboard products can be simultaneously produced with enhanced production efficiency. In addition, a plurality of corrugated paperboard products each having the same length in the feed direction can be produced.

Preferably, in the slitter-scorer apparatus of the present invention, the slitter is adapted to slit the corrugated paperboard sheet along the feed direction so as to form at least two corrugated paperboard sheet portions arranged in the crosswise direction, and each of the scorers is adapted to score the at least two corrugated paperboard sheet portions. Further, the feed line of the corrugated paperboard sheet in the dry end of the corrugator machine is provided with a cutter for cutting the corrugated paperboard sheet along the crosswise direction, wherein the cutter comprises an upper cutter and a lower cutter which are disposed in a two-tiered arrangement with respect to the feed line, wherein the at least two corrugated paperboard sheet portions after being slit and scored by the slitter and the scorers are fed to the upper cutter and the lower cutter, separately.

According to the present invention described above, the at least two corrugated paperboard sheet portions after being slit and scored by the slitter and the scorers are fed separately to the upper cutter and the lower cutter which are disposed in a two-tiered arrangement with respect to the feed line. Thus, two or more corrugated paperboard products can be simultaneously produced with enhanced production efficiency, based on the corrugated paperboard sheet portion to be fed to the upper cutter, and the corrugated paperboard sheet portion to be fed to the lower cutter.

Preferably, in the above slitter-scorer apparatus, the slitter is adapted to slit the corrugated paperboard sheet in such a manner that each of the at least two corrugated paperboard sheet portions has a same or different length in the crosswise direction, and each of the upper and lower cutters is adapted to cut a corresponding one or more of the at least two corrugated paperboard sheet portions into pieces each having a same or different length in the feed direction.

According to the present invention described above, the at least two corrugated paperboard sheet portions are cut into pieces each having a same or different length in the crosswise direction and/or the feed direction. Thus, plural types of corrugated paperboard products having various sizes can be produced. In particular, the combination of the splitter and the double cutter makes it possible to efficiently produce various types of corrugated paperboard products. Further, the at least two corrugated paperboard sheet portions can be synchronously cut by the upper and lower cutters, to produce the same type of corrugated paperboard products.

According to a second aspect of the present invention, there is provided a scorer apparatus provided in a feed line of a corrugated paperboard sheet, in a dry end of a corrugator machine, which comprises: a plurality of scorers for scoring the corrugated paperboard sheet along a feed direction of the corrugated paperboard sheet, wherein each of the scorers is adapted to be displaced in a crosswise direction perpendicular to the feed direction and to a given position of the corrugated paperboard sheet, and made up of a pair of upper and lower segments at least one of which is adapted to be displaced in a vertical direction to adjust a gap therebetween, during the scoring; scorer control means operable to control the crosswise and/or vertical displacements of each of the scorers, and a management section operable, based on the given order information, to provide to the scorer control means information about computational processing for the scoring of the corrugated paperboard sheet, wherein the management section includes displacement amount control means operable to provide information to the scorer control means as a part of the information about computational processing for the scoring, in such a manner as to allow the scorer control means to control respective vertical displacement amounts of the scorers individually on a scorer-by-scorer basis during the scoring.

In the scorer apparatus of the present invention, score lines are formed under a condition that the respective vertical displacement amounts of the scorers are controlled individually on a scorer-by-scorer basis. This makes it possible to obtain a plurality of desired score lines in one lot and through a single-step scoring process. That is, in an operation of forming a plurality of score lines different in depth or size, and configuration, such score lines can be obtained in one lot and through a single-step scoring process with enhanced production efficiency even in small orders.

According to a third aspect of the present invention, there is provided a corrugator machine for a corrugated paperboard sheet, which comprises: a double facer; a slitter for slitting a corrugated paperboard sheet fed from the double facer, along a feed direction of the corrugated paperboard sheet; a plurality of scorers for scoring the corrugated paperboard sheet along the feed direction, wherein each of the scorers is adapted to be displaced in a crosswise direction perpendicular to the feed direction and to a given position of the corrugated paperboard sheet, and made up of a pair of upper and lower segments at least one of which is adapted to be displaced in a vertical direction to adjust a gap therebetween, during the scoring, scorer control means operable to control the crosswise and/or vertical displacements of each of the scorers, displacement-amount control means operable, based on given order information, to provide information to the scorer control means in such a manner as to allow the scorer control means to control respective vertical displacement amounts of the scorers individually on a scorer-by-scorer basis during the scoring; and a cutter for cutting the corrugated paperboard sheet fed from the slitter and the scorers, along the crosswise direction, wherein the cutter consists of a single cutter which is provided in a number of one to the feed line, or comprises an upper cutter and a lower cutter which are disposed in a two-tiered arrangement with respect to the feed line.

In the corrugator machine of the present invention, which comprises the double facer, the slitter for slitting the corrugated paperboard sheet along the feed direction, the plurality of scorers for scoring the corrugated paperboard sheet along the feed direction, and the cutter for cutting the corrugated paperboard sheet along the crosswise direction, when the cutter is a single cutter which is provided in a number of one to the feed line, corrugated paperboard products, particularly having a large size, can be produced. When the cutter comprises an upper cutter and a lower cutter which are disposed in a two-tiered arrangement with respect to the feed line, corrugated paperboard products, particularly having various sizes, can be produced. In addition, score lines are formed under a condition that the respective vertical displacement amounts of the scorers are controlled individually on a scorer-by-scorer basis. This makes it possible to obtain a plurality of desired score lines in one lot and through a single-step scoring process. That is, in an operation of forming a plurality of score lines different in depth or size, and configuration, such score lines can be obtained in one lot and through a single-step scoring process with enhanced production efficiency even in a small-lot order.

As above, the present invention can provide a scorer apparatus for a corrugated paperboard sheet, which is capable of obtaining a plurality of desired score lines in one lot and through a single-step scoring process.

### BRIEF DESCRIPTION OF THE DRAWINGS

In the accompanying drawings:

FIG. 1 is a side view showing a common mechanical structure in respective slitter-scorer apparatuses according to first and second embodiments of the present invention;

FIG. 2 is a front view showing a scorer unit in the slitter-scorer apparatuses according to the first and second embodiments;

FIG. 3 is a side view showing an upper-scorer and a lower-scorer in the slitter-scorer apparatuses according to the first and second embodiments; and

FIG. 4 is a front view showing the upper-scorer and the lower-scorer in the slitter-scorer apparatuses according to the first and second embodiments.

FIGS. 5(a) to 5(c) illustrate a point-to-point scoring mode in the slitter-scorer apparatuses according to the first and second embodiments, wherein FIGS. 5(a) and 5(b) are front views showing two examples of respective configurations of the upper-scorer and the lower-scorer for the point-to-point scoring mode, and FIG. 5(c) is a front view showing a corrugated paperboard sheet after scoring.

FIGS. 6(a) and 6(b) illustrate a three-point scoring mode in the slitter-scorer apparatuses according to the first and second embodiments, wherein FIG. 6(a) is a front view showing respective configurations of the upper-scorer and the lower-scorer for the three-point scoring mode (the right figure shows the configurations for the point-to-point scoring mode for comparison), and FIG. 6(b) is a front view showing a corrugated paperboard sheet after scoring.

FIGS. 7(a) and 7(b) illustrate an offset scoring mode in the slitter-scorer apparatuses according to the first and second embodiments, wherein FIG. 7(a) is a front view showing respective configurations of the upper-scorer and the lower-scorer for the offset scoring mode (the right figure shows the configurations for the point-to-point scoring mode for comparison), and FIG. 7(b) is a front view showing a corrugated paperboard sheet after scoring.

FIG. 8 is a block diagram showing a control system of the slitter-scorer apparatus according to the first embodiment.

FIG. 9 illustrates one example of data to be imported into the control system illustrated in FIG. 8, in the slitter-scorer apparatus according to the first embodiment.

FIG. 10 is a conceptual explanatory diagram showing a corrugated paperboard sheet to be scored by the slitter-scorer apparatus according to the first embodiment.

FIG. 11 is a flowchart showing a process of controlling a plurality of scorers by a CPU-based computing device of the control system illustrated in FIG. 8, in the slitter-scorer apparatus according to the first embodiment.

FIG. 12 is a schematic diagram showing a structure of a dry end of a corrugator machine equipped with the slitter-scorer apparatus according to the first embodiment.

FIG. 13 is a block diagram showing a control system of the slitter-scorer apparatus according to the second embodiment.

FIG. 14 illustrates one example of data to be imported into the control system illustrated in FIG. 13, in the slitter-scorer apparatus according to the second embodiment.

FIG. 15 is a conceptual explanatory diagram showing a corrugated paperboard sheet to be scored by the slitter-scorer apparatus according to the second embodiment.

FIG. 16 is a flowchart showing a process of controlling a plurality of scorers by a CPU-based computing device of the control system illustrated in FIG. 13, in the slitter-scorer apparatus according to the second embodiment.

FIG. 17 is a schematic diagram showing a structure of a dry end of a corrugator machine equipped with the slitter-scorer apparatus according to the second embodiment.

### DETAILED DESCRIPTION OF THE PREFERRED EMBODIMENTS

With reference to the drawings, the present invention will now be described based on a preferred embodiment thereof. Although the following embodiment will be described based on one example where the present invention is applied to a slitter-scorer apparatus comprising a slitter and a scorer which are arranged side by side in series, the present invention may also be applied to a scorer apparatus itself.

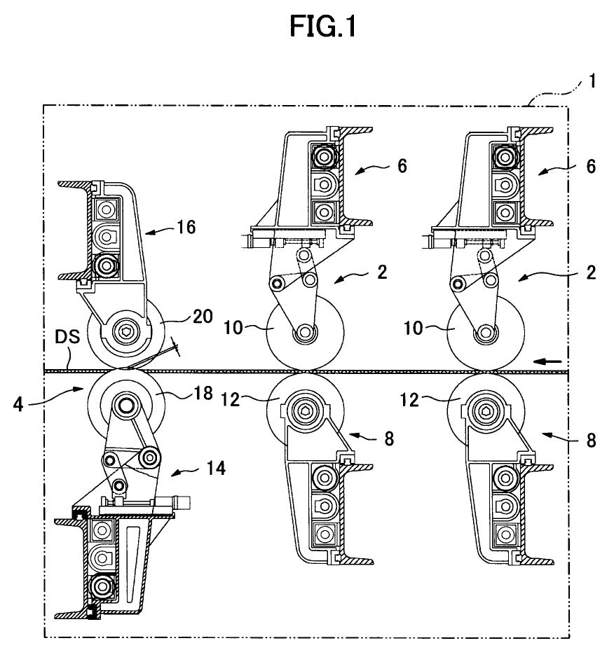

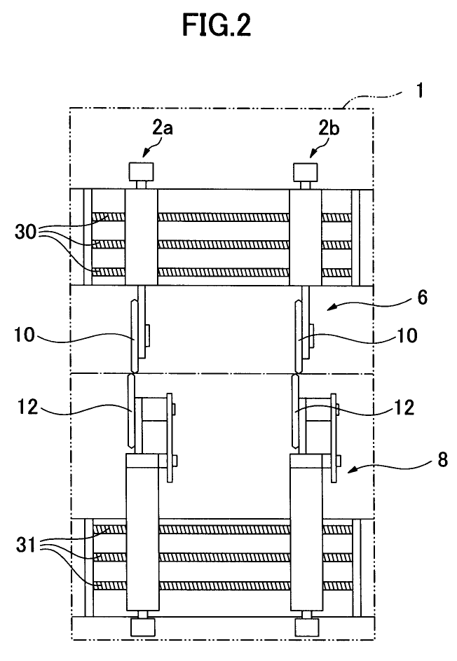

With reference to FIGS. 1 and 2, a common mechanical structure (hereinafter referred to as “slitter-scorer unit 1”) in respective slitter-scorer apparatuses according to first and second embodiments of the present invention will be firstly described.

FIG. 1 is a side view showing the slitter-scorer unit 1 in the slitter-scorer apparatuses according to the first and second embodiments, and FIG. 2 is a front view showing a scorer unit in the slitter-scorer apparatuses according to the first and second embodiments. Although the following description will be made primarily based on a slitter-score unit of the slitter-scorer apparatus according to the first embodiment, it is understood that details of the slitter-score unit 1, such as the number of slitters and/or the number of scorers, may be appropriately modified according to need.

As shown in FIG. 1, the slitter-scorer unit 1 comprises two sets of scorers 2 disposed on an upstream side in a feed direction (traveling direction) of a corrugated paperboard sheet DS and arranged side by side along the feed direction, and one set of slitters 4 disposed downstream of the scorer 2. As shown in FIG. 2, each of the two set of scorers 2 includes two scorers arranged side by side in a crosswise direction (widthwise direction) approximately perpendicular to the feed direction (the two crosswise arranged scorers will hereinafter be referred to as “scorers 2a, 2b”, as necessary to be specified). Although not illustrated, the set of slitters 4 includes three slitters arranged side by side in the crosswise direction. Each of the scorers 2a, 2b and the slitters 4 is adapted to be displaceable in the crosswise direction independently, and positionally adjusted in the crosswise direction, in response to changes in the number of products and a width of a product in connection with each order change.

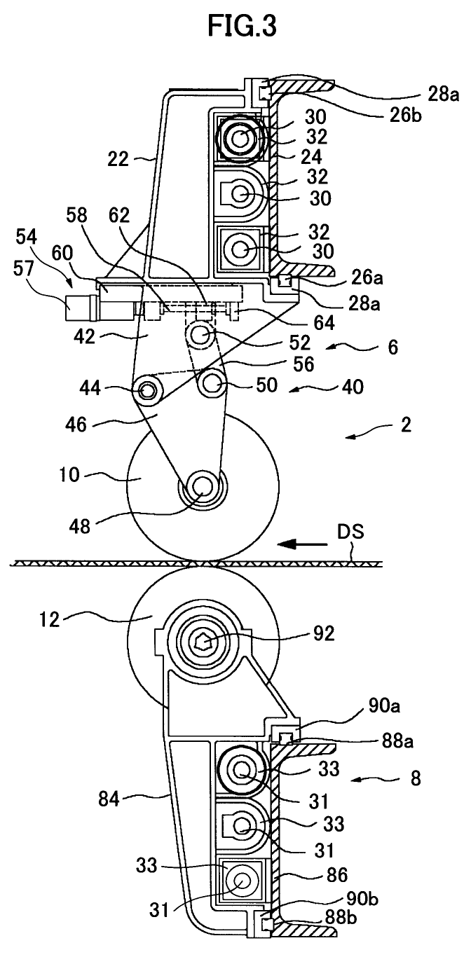

With reference to FIG. 3, the scorer 2 will be specifically described below. FIG. 3 is a side view showing an upper-scorer and a lower-scorer in the slitter-scorer apparatuses according to the first and second embodiments.

As shown in FIG. 3, the scorer 2 comprises an upper-scorer 6 and a lower-scorer 8 which are disposed respectively above and below with respect to a paper line (i.e., a substantially straight or planar path) along which the corrugated paperboard sheet DS travels. The upper-scorer 6 is provided with an upper scoring roll 10, and the lower-scorer 8 is provided with a lower scoring roll 12. In the first and second embodiments, only the upper scoring roll 10 of the upper-scorer 6 is adapted to be displaced in an upward-downward (i.e., vertical) direction between a loaded position where a scoring operation is performed (i.e., where a score line is formed), and an unloaded position where the scoring operation is released (i.e., where no score line is formed). In this respect, the upper scoring roll 10 is an active scoring roll, whereas the lower scoring roll 12 is a passive scoring roll. The lower scoring roll 12 serves as a means to support a load from the upper scoring roll 10 during the scoring operation. Thus, the lower scoring roll 12 is fixed at a position where it holds a lower surface of the corrugated paperboard sheet DS which is traveling along the paper line.

The slitter 4 will be described below. As shown in FIG. 1, the slitter 4 comprises a lower-slitter 14 and an upper-slitter 16. The slitter 4 is a so-called “lower single-blade type” where a slitter knife 18 provided in the lower-slitter 14 and a slitter-receiving member 20 provided in the upper-slitter 16 are arranged on respective opposite sides of the paper line. The lower-slitter 14 includes a vertical displacement mechanism adapted to allow the lower scoring roll 12 to be vertically displaced.

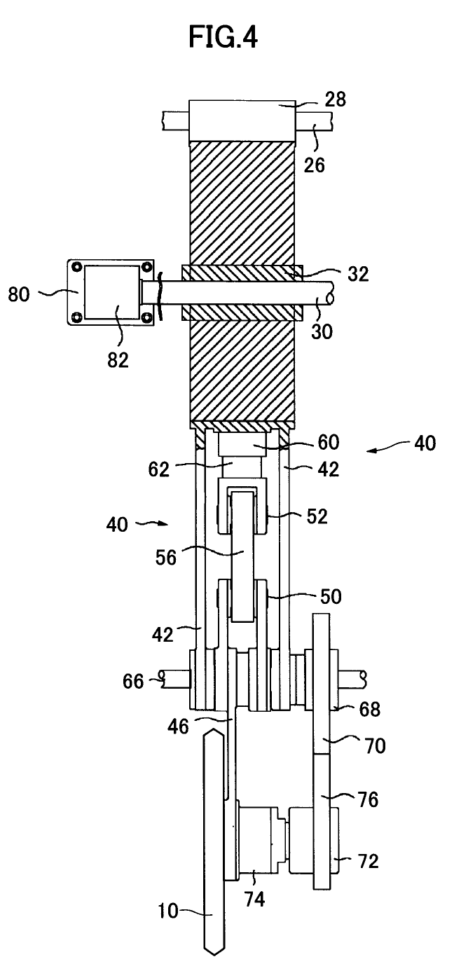

With reference to FIGS. 1 to 4, the upper-scorer and the lower-scorer in the slitter-scorer apparatuses according to the first and second embodiments will be more specifically described below. FIG. 4 is a front view showing the upper-scorer and the lower-scorer in the slitter-scorer apparatuses according to the first and second embodiments.

The upper-scorer 6 will be firstly described. As shown in FIGS. 3 and 4, an upper-scorer frame 22 is slidably mounted to two guide rails 26a, 26b of a stay 24 through two support members 28a, 28b, respectively, wherein the stay 24 is fixedly mounted across a frame (not shown). As shown in FIG. 4, the upper-scorer 6 is fixed to the upper-scorer frame 22, and adapted to be displaced in the crosswise direction so as to be set at a position corresponding to each production order, based on a crosswise displacement mechanism which comprises three screw shafts 30 (see FIG. 2) each of which is rotatably mounted across a frame (not shown) and which are screwed, respectively, with three bearing members 32 (see FIG. 3) fixedly mounted to the upper-scorer frame 22.

The upper scoring roll 10 is attached to the upper-scorer frame 22 through a vertical displacement mechanism 40 adapted to allow the upper scoring roll 10 to be vertically displaced between the loaded position for scoring/deforming the traveling corrugated paperboard sheet DS, and the unloaded position. Specifically, the vertical displacement mechanism 40 comprises a first arm 42 fixed to the upper-scorer frame 22, and a second arm 46 swingably connected to the first arm 42 through a pivot shaft 44. The second arm 46 rotatably supports the upper scoring roll 10 through a pivot member 48. The vertical displacement mechanism 40 further comprises a linkage comprised of a link arm 56 which has one end connected to the second arm 46 through a first support member 50, and the other end connected to a swing mechanism 54 through a second support member 52.

The swing mechanism 54 comprises a driving device 57, a screw shaft 58 having one end connected to the driving device 57, a slide member 62 screwed with the screw shaft 58 in such a manner as to be slidably moved on the screw shaft 58 and along a slide rail 60, and a screw shaft-support base 64 disposed at a position opposed to the driving device 57 to rotatably support the other end of the screw shaft 58. The driving device 57 is comprised of a servomotor, such as an AC servomotor. The servomotor employed as the driving device 57 is excellent in vertical-position resolution (e.g., 0.1 mm) of the upper scoring roll 10. This makes it possible to continuously perform a positioning control for the upper scoring roll 10. The driving device 57 may use any other suitable driving source, such as air pressure or oil pressure.

Based on the above structure, the vertical displacement mechanism 40 is operable as follows. Upon activation of the driving device 57 of the swing mechanism 54, the screw shaft 58 is rotated, and thereby the slide member 62 screwed with the screw shaft 58 is slidingly moved along the slide rail 60, together with the link arm 56 attached thereto. Thus, in conjunction with movement of the link arm 56, the first support member 50 connecting between the link arm 56 and the second arm 46 is swingingly moved about the pivot shaft 44 connecting between the second arm 46 and the first arm 42.

As shown in FIG. 4, the upper-scorer 6 further includes a drive shaft 66 disposed to extend approximately parallel to the screw shafts 30, a first driving-force transmitting member 70 fixed to the drive shaft 66 through a first retainer 68 retaining the first driving-force transmitting member 70, and a second driving-force transmitting member 76 fixed to an intermediate shaft 72 through a second retainer 72 retaining the second driving-force transmitting member 76, which are made up of a rotational drive mechanism, in cooperation with the vertical displacement mechanism 40 attached to the upper-scorer frame 22 and others.

The drive shaft 66 is rotatably supported by the first arm 42 and second arm 45 through a bearing or the like, to serve as the pivot shaft 44. Thus, a rotational driving force from a scoring-roll driving device (not shown) is transmitted from the drive shaft 66 to the upper scoring roll 10 via the first driving-force transmitting member 70 and the second driving-force transmitting member 76. The first driving-force transmitting member 70 is adapted, when the upper scoring roll 10 is displaced along the screw shafts 30 in the crosswise direction, to be slidably moved on the drive shaft 66 in the same direction.

As best shown in FIG. 4, the crosswise displacement (positioning) mechanism of the upper-scorer 6 is operable as follows. In response to activation of a driving device 82 fixed to a frame or the like of the scorer 2 and adapted to drivingly rotate each of the screw shafts 30 screwed with respective ones of the bearing members 32 fixedly mounted to the upper-scorer frame 22 for the upper-scorer 6, the screw shafts 30 are rotated, and thereby the upper-scorer 6 is displaced on the screw shafts 30 in the crosswise direction through the bearing members 32. The driving device 82 is comprised of a servomotor, such as an AC servomotor.

The lower-scorer 8 will be described below. Except that the lower scoring roll 8 is not displaced between the loaded position and the unloaded position, a support structure and a crosswise displacement mechanism of the lower-scorer 8 are the same as those of the upper-scorer 6. Specifically, as shown in FIG. 3, the lower-scorer frame 84 is slidably mounted to two guide rails 88a, 88b of a stay 86 through two support members 90a, 90b, respectively, wherein the stay 86 is fixedly mounted across a frame (not shown). The lower-scorer 8 is fixed to the lower-scorer frame 84, and adapted to be displaced in the crosswise direction so as to be set at a position corresponding to each production order, based on a crosswise displacement mechanism which comprises three screw shafts 31 (see FIG. 2) each of which is rotatably mounted across a frame (not shown) and which are screwed, respectively, with three bearing members 33 fixedly mounted to the lower-scorer frame 84.

The lower scoring roll 12 is rotatably supported by the lower-scorer frame 84 through a pivot portion 92. The lower scoring roll 12 is disposed in opposed relation to the upper scoring roll 10 to score (i.e., form a score line) the traveling corrugated paperboard sheet DS. Preferably, a vertical position of the lower scoring roll 12 relative to the traveling corrugated paperboard sheet DS is set such that the lower scoring roll 12 is in contact with a lower surface of the corrugated paperboard sheet DS. In this case, the lower scoring roll 12 may be positively rotated by a rotational drive mechanism (not shown), or may be simply brought into contact with the traveling corrugated paperboard sheet DS and rotated according to a friction force generated by the contact.

As shown in FIGS. 2 and 3, the three screw shafts 31 are shared by the two scorers 2a, 2b arranged side by side in the crosswise direction, so that each of the lower-scorers 8 of the two scorers 2a, 2b can be simultaneously displaced and positioned in the crosswise direction through the three bearing members 33.

Although not specifically described, each of the three slitters 4 has substantially the same crosswise displacement mechanism as that of the slitters 2.

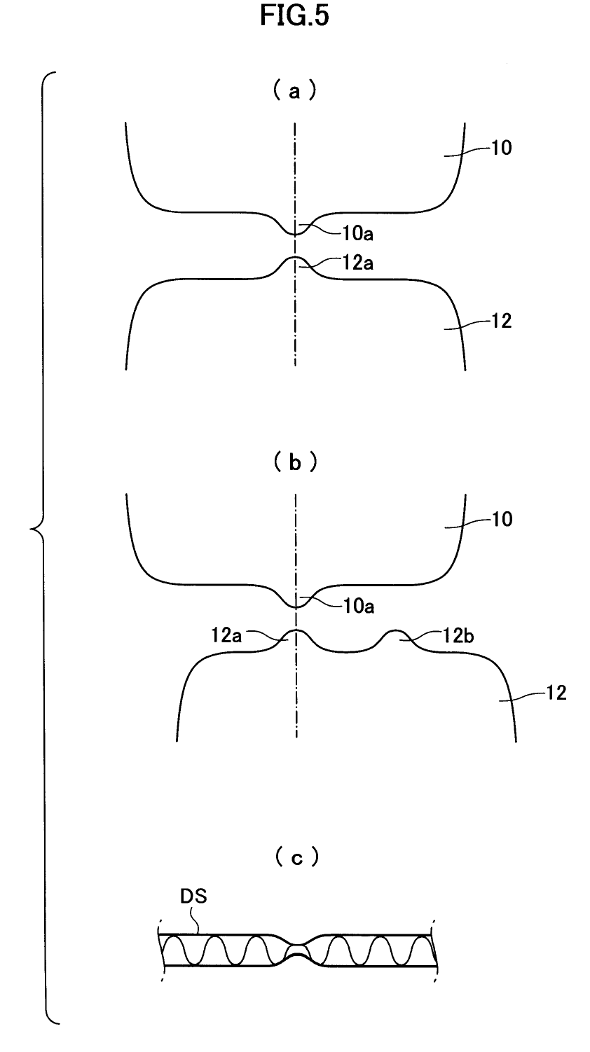

With reference to FIGS. 5(a) to 7(b), respective configurations of the upper scoring roll 10 and the lower scoring roll 12 for forming a score line with a specific configuration in a corrugated paperboard sheet will be described below.

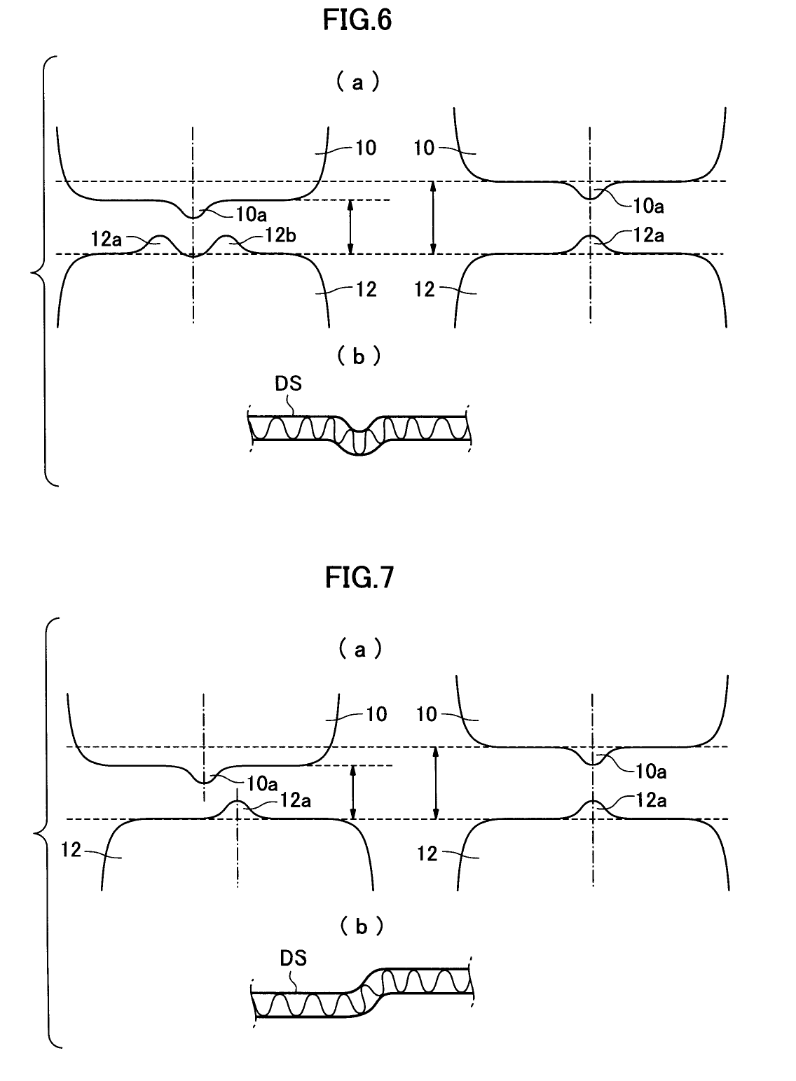

FIGS. 5(a) to 5(c) illustrate a point-to-point scoring mode in the slitter-scorer apparatuses according to the first and second embodiments, wherein FIGS. 5(a) and 5(b) are front views showing two examples of respective configurations of the upper-scorer and the lower-scorer for the point-to-point scoring mode, and FIG. 5(c) is a front view showing a corrugated paperboard sheet after scoring. FIGS. 6(a) and 6(b) illustrate a three-point scoring mode in the slitter-scorer apparatuses according to the first and second embodiments, wherein FIG. 6(a) is a front view showing respective configurations of the upper-scorer and the lower-scorer for the three-point scoring mode (the right figure shows the configurations for the point-to-point scoring mode for comparison), and FIG. 6(b) is a front view showing a corrugated paperboard sheet after scoring. FIGS. 7(a) and 7(b) illustrate an offset scoring mode in the slitter-scorer apparatuses according to the first and second embodiments, wherein FIG. 7(a) is a front view showing respective configurations of the upper-scorer and the lower-scorer for the offset scoring mode (the right figure shows the configurations for the point-to-point scoring mode for comparison), and FIG. 7(b) is a front view showing a corrugated paperboard sheet after scoring.

As shown in FIGS. 5(a) and 5(b), in a point-to-point scoring mode, the upper scoring roll 10 and the lower scoring roll 12 are formed with respective ones of a pair of protrusions 10a, 12b located in opposed relation to each other at a common position. In the first and second embodiments, during a scoring operation, the upper scoring roll 10 (upper-scorer 6) is displaced downwardly to come close to the lower scoring roll 12 (lower-scorer 8) so as to form a score line in a corrugated paperboard sheet DS. That is, respective configurations of the protrusions 10a, 12b are directly transferred to the corrugated paperboard sheet DS, as shown in FIG. 5(c). FIG. 5(a) shows one example where each of the upper scoring roll 10 and the lower scoring roll 12 is formed with one protrusion (10a, 12a), and FIG. 5(b) shows another example where the upper scoring roll 10 is formed with one protrusion (10a), and the lower scoring roll 12 is formed with two protrusions (12a, 12b). In FIGS. 5(a) and 5(b), the one-dot chain line shows that respective apexes of the protrusions of the upper and lower scoring rolls 10, 12 are substantially aligned with each other vertically.

As shown in FIG. 5(a), in a three-point scoring mode, the upper scoring roll 10 is formed with one protrusion 10a, and the lower scoring roll 12 is formed with two protrusions 12a, 12b, wherein the protrusion 10a of the lower scoring roll 12 is located at an intermediate position between the protrusions 12a, 12b of the lower scoring roll 12. In the lower scoring roll 12, a recess is defined between the protrusions 12a, 12b. In the first and second embodiments, during a scoring operation, the upper scoring roll 10 (upper-scorer 6) is displaced downwardly to come close to the lower scoring roll 12 (lower-scorer 8) so as to form a score line in a corrugated paperboard sheet DS. Through the scoring operation, a score line as shown in FIG. 6(b) is obtained in the corrugated paperboard sheet DS by the configurations of the upper and lower scoring rolls 10, 12.

As shown in FIG. 7(a), in an offset scoring mode, the upper scoring roll 10 is formed with one protrusion 10a, and the lower scoring roll 12 is formed with one protrusion 12a, wherein the protrusion 10a of the lower scoring roll 12 and the protrusion 12a of the lower scoring roll 12 are located at mutually offset positions in the crosswise direction. In the first and second embodiments, during a scoring operation, the upper scoring roll 10 (upper-scorer 6) is displaced downwardly to come close to the lower scoring roll 12 (lower-scorer 8) so as to form a score line in a corrugated paperboard sheet DS. Through the scoring operation, a score line as shown in FIG. 7(b) is obtained in the corrugated paperboard sheet DS by the configurations of the upper and lower scoring rolls 10, 12. The protrusion 10a of the upper scoring roll 10 may be offset on an opposite side to that in FIG. 7(a), relative to the protrusion 12a of the lower scoring roll 12.

In the first and second embodiments, in a certain lot, the scorers 2 can be used in the plurality of the scoring modes as shown in FIGS. 5(a), 5(b), 6(a) and 7(a) in various combinations.

In the first embodiment, the above slitter-scorer unit 1 can be used in a feed line of a dry end 200 of a corrugator, together, for example, with a double facer 202, a single cutter 204 and a defective removing unit 206 (see FIG. 12). In an example illustrated in FIG. 1, one slitter-scorer unit 1 is provided in the feed line in the corrugator dry end 200. Alternatively, two or more slitter-scorer units 1 may be provided therein. The double facer 202 is designed to join a liner to a single faced corrugated paperboard sheet (formed by bonding a corrugated medium to one liner) so as to produce a double faced corrugated paperboard sheet having a multi-layer structure made up of a liner, a corrugated medium and a liner.

The single cutter 204 is a single-tiered cutter for cutting a corrugated paperboard sheet DS fed from the slitter-scorer unit 1, and disposed downstream of the slitter-scorer unit 1. The single cutter 204 has a pair of cutter cylinders 210a, 210b which are adapted to cut the corrugated paperboard sheet DS in the crosswise direction perpendicular to the feed direction of the corrugated paperboard sheet DS.

For example, in cases where the corrugated paperboard sheet DS is slit using one of the slitters 4, and divided into right and left portions with respect to the feed direction, the divided right and left portions are simultaneously cut by the single cutter 204. The same operation is performed in cases where the corrugated paperboard sheet DS is slit using two or more of the slitters 4, and divided into three or more portions each extending in the feed direction with the same or different widths.

In cases where the corrugated paperboard sheet DS is not slit without using the slitters 4, i.e., the corrugated paperboard sheet DS is not divided into two or more portions with respect to the feed direction, the corrugated paperboard sheet DS is fed to the single cutter 204 in the form of a single piece.

A slitter-scorer apparatus according to the first embodiment which has the above slitter-scorer unit 1 to be applied to the dry end 200 of the corrugator (corrugator machine) will be described below.

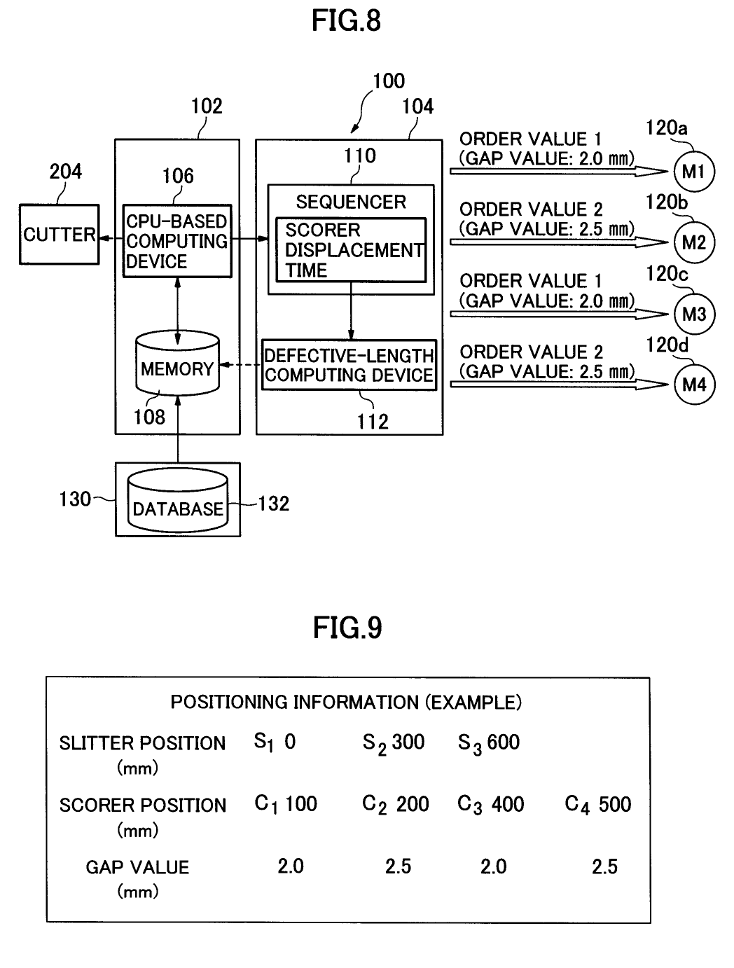

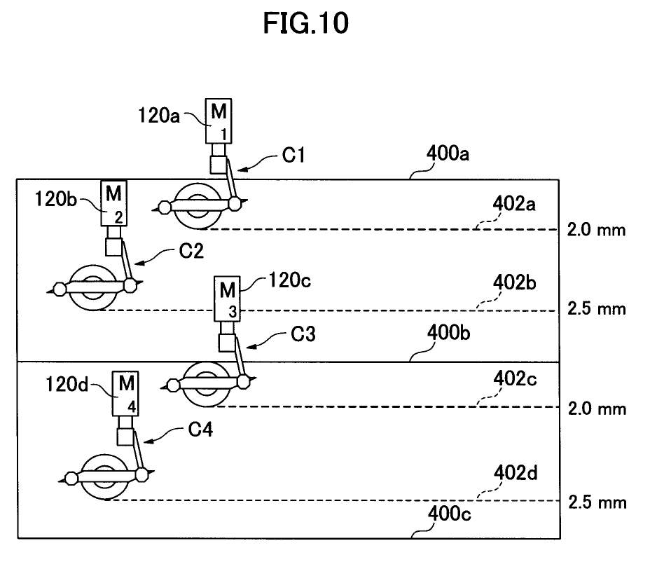

With reference to FIGS. 8 to 10, a configuration of a control system of the slitter-scorer apparatus according to the first embodiment will be firstly described. FIG. 8 is a block diagram showing the control system of the slitter-scorer apparatus according to the first embodiment. FIG. 9 illustrates one example of data to be imported into the control system illustrated in FIG. 8, in the slitter-scorer apparatus according to the first embodiment, and FIG. 10 is a conceptual explanatory diagram showing a corrugated paperboard sheet to be scored by the slitter-scorer apparatus according to the first embodiment.

As shown in FIG. 8, the control system 100 primarily comprises a management section 102 and a slitter-scorer control section 104. The management section 102 includes a CPU-based computing device 106 and a memory (storage device) 108. The slitter-scorer control section 104 primarily includes a sequencer 110 and a defective-length computing device 112.

For example, order information as shown in FIG. 9 is imported from a database 132 of a computer 130 placed in an office outside a plant, to the memory 108. The order information includes production order data which orders a scoring pressure of each of the scorers and a type of score line, based on any one or a combination of two or more of a flute and a paper quality of the corrugated paperboard sheet, and an area and a quality of a print to be applied to a corrugated paperboard sheet product in a carton forming process, and other production order data including information about the carton forming process under management. In the first embodiment, the management section 102 is operable to receive the production order data from the external computer having the database 132 and adjust a scoring operation while additionally taking account of conditions (print, etc) of a final product to be produced through the subsequent carton forming process. The management section 102 utilizes the external computer 103 in the above manner to allow the slitter-scorer control section 104, the management section 102 and the external computer 130 to share a plurality of rolls so as to achieve a function of forming plural types of score lines in one lot effectively and accurately, which was conventionally unachievable.

In FIG. 9, respective crosswise positions of the three slitters S1, S2, S3 of the slitter-scorer unit 1 are specified by a numerical value on millimeter scale, and respective crosswise positions of the four scorers C1, C2, C3, C4 of the slitter-scorer unit 1 are specified by a numerical value on millimeter scale.

Further, respective inter-roll gap values (or scoring displacement amounts) of the four scorers C1, C2, C3, C4 are also specified. In the following description, a position where the upper scoring roll 10 is initially brought into contact with the corrugated paperboard sheet DS when it is displaced downwardly from the unloaded position in FIG. 5(a), 5(b), 6(a) or 7(a) will be referred to as “lowermost position of the upper scoring roll”, a position where the lower scoring roll 12 is in contact with the lower surface of the corrugated paperboard sheet DS will be referred to as “uppermost position of the lower scoring roll”. In the first embodiment, the inter-roll gap value (hereinafter referred to simply as “gap value”) means a numerical value representing a gap between the upper scoring roll 10 and the lower scoring roll 12 in a state after the upper scoring roll 10 is displaced downwardly from the unloaded position to the loaded position. In the first embodiment, the scoring displacement amount means an amount (distance) by which the upper scoring roll 10 is to be displaced, from a state when the upper scoring roll 10 is in the lowermost position and the lower scoring roll 12 is in the uppermost position. For example, a scoring displacement amount is set to obtain a given gap value, or a gap value is set to obtain a given scoring displacement amount.

In the example illustrated in FIG. 9, the gap value of each of the scorer C1 and the scorer C3 is specified as 2.0 mm. Thus, in each of the scorers C1, C3, the upper scoring roll 10 will be displaced downwardly by a scoring displacement amount allowing the gap value to be set at 2.0 mm, so that the protrusions 10a, 12a of the upper and lower scoring rolls 10, 12 as shown in FIG. 5(a), 5(b) or 7(a) or the protrusions 10a, 12a, 12b of the upper and lower scoring rolls 10, 12 as shown in FIG. 6(a) will be pressed against the corrugated paperboard sheet DS to obtain a score line having the configuration as shown in FIG. 5(c), FIG. 7(b) or FIG. 6(b).

Further, the gap value of each of the scorers C2, C4 is specified as 2.5 mm. Thus, in each of the scorers C2, C4, the upper scoring roll 10 will be displaced downwardly by a scoring displacement amount allowing the gap value to be set at 2.5 mm, so that the protrusions 10a, 12a of the upper and lower scoring rolls 10, 12 as shown in FIG. 5(a), 5(b) or 7(a) or the protrusions 10a, 12a, 12b of the upper and lower scoring rolls 10, 12 as shown in FIG. 6(a) will be pressed against the corrugated paperboard sheet DS to obtain a score line having the configuration as shown in FIG. 5(c), FIG. 7(b) or FIG. 6(b).

The data for each of the slitters and the scorers as shown in FIG. 9 is stored in the memory 108 of the management section 102, and the CPU-based computing device 106 is operable to provide the data as shown in FIG. 9 to the sequencer 110 of the slitter-scorer control section 104, as an order. Then, the sequencer 110 is operable, based on the order, to send the order values to respective servomotors (not shown) of the slitters S1, S2, S3 and respective servomotors 120a, 120b, 120c, 120d of the scorers C1, C2, C3, C4, as shown in FIGS. 8 and 10, so as to control each of the servomotors. Through the control, each of the slitters and the scorers is positioned in the crosswise direction, and each of the scorers is displaced downwardly, according to the order values as shown in FIG. 9, so that a slit line and a score line are formed, as shown in FIG. 10.

As the scoring displacement amount of each of the scorers C1, C2, C3, C4 as shown in FIG. 9, a retraction value may be entered. For example, when the retraction value is set at 10 mm, the upper scoring roll 10 will be displaced upwardly from the lowermost position to preclude a scoring operation.

In FIG. 10, the reference codes 400a, 400b, 400c indicate respective slit lines formed by the slitters S1, S2, S3, and the reference codes 402a, 402b, 402c, 402d indicate respective score lines formed by the scorers C1, C2, C3, C4.

In the first embodiment, each of the scorers C1, C2, C3, C4 is designed to be used in the pint-to-point mode as shown in FIG. 5(a) or 5(b). In this case, in each of the scorers C1, C3 having a relatively large scoring displacement amount, a scoring operation is performed under a relatively high scoring pressure, whereas, in each of the scorers C2, C4 having a relatively small scoring displacement amount, a scoring operation is performed under a relatively low scoring pressure.

As above, the gap values (or scoring displacement amounts) of the scorers C1, C2, C3, C4 can be set individually. For example, in the above case, a score line formed in the corrugated paperboard sheet DS by each of the scorers C1, C3 having a relatively high scoring pressure can have a relatively high foldability, and a score line formed in the corrugated paperboard sheet DS by each of the scorers C2, C4 having a relatively low scoring pressure can have a relatively low foldability. This makes it possible to specify a sequence of folding the corrugated paperboard sheet DS, in the order of a score line formed under a relatively high scoring pressure to a score line formed under a relatively low scoring pressure.

When the scoring pressure is lowered, a depth and size of a depression of a score line are reduced. Thus, even if a solid print is formed on the score line, deterioration in appearance (e.g., fading) of the print can be avoided. In other words, the scoring pressure for a score line which passes through a printing area can be lowered to obtain an excellent printing result.

In this manner, the gap values (or scoring displacement amounts) of the scorers C1, C2, C3, C4 are set (controlled) individually, depending on a desired depth and size of each of a plurality of score lines to be formed through a scoring operation, so that all the score lines can be adequately formed through a single-step scoring process.

Alternatively, among the scorers C1, C2, C3, C4 illustrated in FIG. 10, the scorers C1, C3 may be designed to be used in the offset mode as shown in FIG. 7(a), and the scorer C2, C4 may be designed to be used in the point-to-point mode as shown in FIG. 5(a) or 5(b). As shown in FIG. 7(a) (right and left figures), in the offset mode, the upper scoring roll 10 has to be displaced closer to the lower scoring roll 12 to obtain a given deformation amount, as compared with the point-to-point mode. In the first embodiment, the gap values (or scoring displacement amounts) of the scorers C1, C2, C3, C4 can be set individually, and therefore the gap values (or scoring displacement amounts) for the pint-to-point mode and the offset mode can be set individually to adequately perform respective scoring operations in the pint-to-point and offset modes. That is, the gap values (or scoring displacement amounts) of the scorers C1, C2, C3, C4 are specified depending on a required configuration (FIG. 5(c), FIG. 6(b), FIG. 7(c)) of each of a plurality of score lines, so that all the score lines can be adequately formed through a single-step scoring process. Further, relative offset positions and an offset distance between the protrusion 10a of the upper scoring roll 10 and the protrusion 12a of the lower scoring roll 12 can also be set individually on a scorer-by-scorer basis.

In the slitter-scorer control section 104, the sequencer 110 is operable to compute respective scorer displacement times of the scorers C1, C2, C3, C4, and then compute a defective length based on the computed scorer displacement times. The defective length is stored in the memory 108 of the management section 102. Then, in the management section 106, the CPU-based computing device 106 is operable to read the stored defective length, and control the single cutter 204 adapted to cut the corrugated paperboard sheet DS into a plurality of pieces each having a given length, to cut off and remove a defective-length portion of the corrugated paperboard sheet DS based on the read defective length.

As above, in the first embodiment, the defective length is computed based on the respective scorer displacement times of the plurality of scorers. This makes it possible to more adequately cut off and remove a defective-length portion.

Further, in this control system 100, the management section 102 is connected to the slitter-scorer control section 104 to control the slitter-scorer unit 1. This makes it possible to effectively control the plurality of scorers through the use of the existing slitter-scorer control section 104.

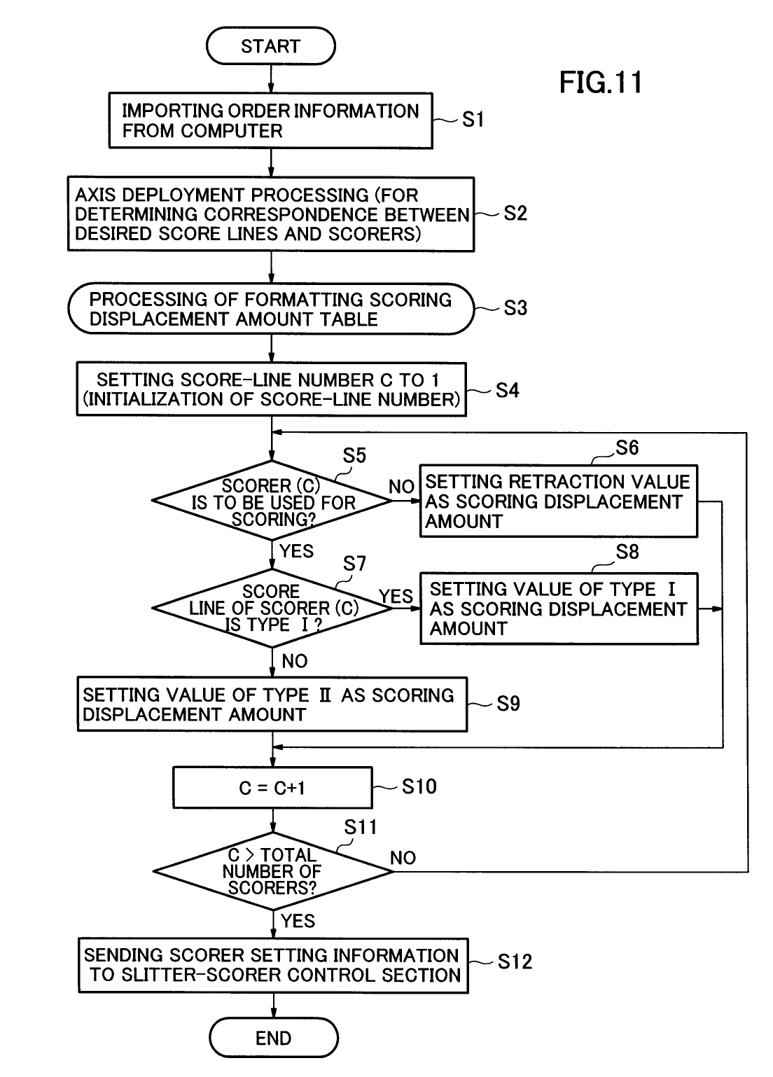

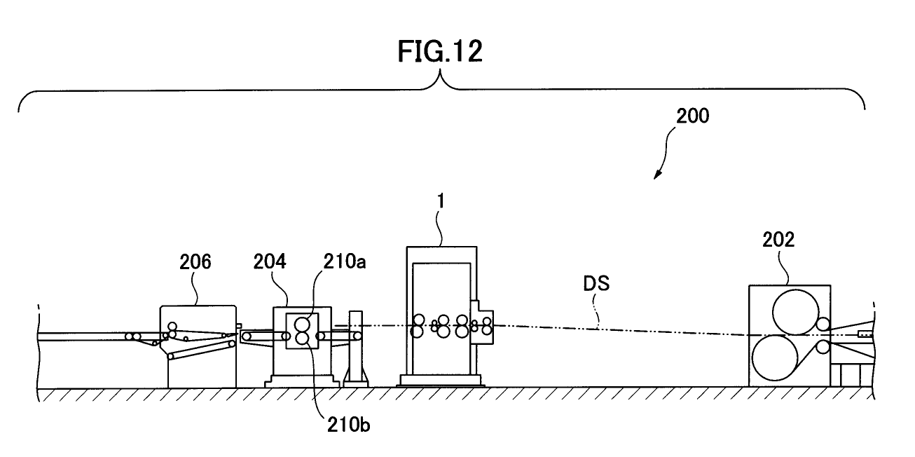

With reference to FIG. 11, details of a control of the CPU-based computing device 106 in the management section 102 will be described below. FIG. 11 is a flowchart showing a process of controlling the plurality of scorers by the CPU-based computing device 106. The following description will be made on an assumption that scoring displacement amounts of a plurality of scorers include three type consisting of a retraction value (for performing no scoring operation), a scoring type I (e.g., 1.7 mm) and a scoring type II (e.g., 1.20 mm).

In Step S1, order information is imported. Specifically, the management section 102 imports order input or production order data as shown in FIG. 9 from the database 132 of the external computer, and stores the imported data in the memory 108, as mentioned above.

In Step S2, an axis deployment processing is performed. This processing is intended to determine a correspondence between respective ones of intended score lines and the scorers to compute a crosswise displacement amount of each of the scorers to be used for forming the intended score lines.

In Step S3, a processing of formatting a scoring displacement amount table is performed. The scoring displacement amount table will be sent to the sequencer 110 in after-mentioned Steps S12.

In Step S4, a scoring number C is set to 1. This processing is intended to initialize the scoring number C.

In Step S5, it is determined whether one (C=1) of the scorers is to be used for scoring. If NO, the routine advances to Step S6. In Step S6, the retraction value is set as the scoring displacement amount. This processing in Step S6 is performed based on data as shown in FIG. 9.

If YES, i.e., the scorer (C=1) is to be used for scoring, the routine advances to Step S7. In Step S7, it is determined whether the scoring displace amount of the scorer (C=1) is the scoring type I. If YES, the routine advances to Step S8. In Step S8, a preset value (e.g., 1.70 mm) of the scoring type I is set as the scoring displacement amount. If NO, i.e., the score line is not the type I, the routine advances to Step S9. In Step S9, a preset value (e.g., 1.20 mm) of the scoring type II is set as the scoring displacement amount.

After Step S8 or Step S9, the routine advances to Step S10. In Step S10, the scoring number C is incremented to 2 (i.e., the previous C+1). Then, in Step S11, it is determined whether the scoring number C is greater than a total number of the scorers (in the example illustrated in FIG. 9, four). If NO, the processings in Steps S5 to S9 will be performed while incrementing the scoring number C to 3 and then to 4, only to the extent that the scoring number C does not become greater than the total number of the scorers.

Then, in Step S12, the scoring displacement amounts obtained through Steps S5 to S9 are sent to the sequencer 104 of the slitter-scorer control section 104, as scorer setting information.

Although the slitter-scorer apparatus according to the first embodiment is designed to form score lines in a direction perpendicular to flutes of a corrugated paperboard sheet, it may be used as a creaser for forming score lines in a direction parallel to flutes of a corrugated paperboard sheet.

With reference to FIG. 12, the dry end 200 of the corrugator equipped with the slitter-scorer apparatus according to the first embodiment will be more specifically described. The corrugator dry end 200 includes the double facer 202. The double facer 202 is designed to bond a liner to a single faced corrugated paperboard sheet so as to produce a double faced corrugated paperboard sheet. The double facer 202 comprises a heating plate 301 and a corrugating belt 303, wherein a single faced corrugated paperboard sheet and a liner are nipped between the heating plate 301 and the corrugating belt 303 and fed while being bonded together and dried.

The corrugated paperboard sheet DS from the double facer 202 is fed to the slitter-scorer apparatus. The slitter-scorer apparatus is designed to form a slit line and a score line parallel to the feed direction of the corrugated paperboard sheet DS, as mentioned above. In the example illustrated in FIG. 12, one slitter-scorer apparatus (slitter-scorer unit 1) is provided in the feed line of the corrugator dry end 200. Alternatively, two slitter-scorer apparatuses may be provided therein.

In a conventional slitter-scorer apparatus, a positioning speed for each yoke is lower than a feed speed of a corrugated paperboard sheet. Thus, as disclosed in the aforementioned patent publications (JP 2002-036171A and U.S. Pat. No. 5,918,519), two slitter-scorer apparatuses are provided, wherein one of the slitter-scorer apparatuses is placed in a standby state after being prepared for dimensions in a next change in product specifications, while slitting/scoring a corrugated paperboard sheet by the other the slitter-scorer apparatus.

In contrast, the slitter-scorer apparatus according to the first embodiment has a relatively high positioning speed. Thus, even if the slitter-scorer apparatus is provided in a number of one, the single slitter-scorer apparatus can adequately cope with an order change. Specifically, an operation (order change operation) of the slitter-scorer apparatus during an order change is completed by displacing each of the slitters and the scorers to a given crosswise position corresponding to the new order at a high speed, while continuing feeding of a corrugated paperboard sheet in the feed line. It is understood that the slitter-scorer apparatus according to the first embodiment may be provided in a plural number.

The corrugated paperboard sheet DS from the slitter-scorer apparatus is fed to the single cutter 204. The single cutter 204 has the pair of cutter cylinders 210a, 210b which are adapted to cut the entire corrugated paperboard sheet DS fed from the slitter-scorer apparatus, in the crosswise direction perpendicular to the feed direction, at a time.

The corrugated paperboard sheet portions from the single cutter 204 are fed to the defective removing unit 206. The defective removing unit 206 is designed to remove a defective corrugated paperboard sheet portion corresponding to a production defect portion detected on an upstream side of the corrugator. In specifications of the corrugator dry end 200 illustrated in FIG. 12, a corrugated paperboard sheet is not cut over the overall width thereof by a rotary shear (see 304 in FIG. 17) during an order change. Thus, a portion of the corrugated paperboard sheet passing through the slitter-scorer apparatus during the order change operation is removed as a defective portion by the defective removing unit 206 just after the single cutter 204. The corrugated paperboard sheet portions from the defective removing unit 206 are fed to a wet end of the corrugator.

The slitter-scorer apparatus according to the second embodiment of the present invention will be described below.

In the second embodiment, the slitter-scorer unit 1 may be used in a feed line of a dry end 300 of a corrugator, together with a double facer 302, a rotary shear 304, a defective removing unit 306, a guide unit 308 and a double cutter 310 (see FIG. 17).

The double facer 302 is designed to join a liner to a single faced corrugated paperboard sheet (formed by bonding a corrugated medium to one liner) so as to produce a double faced corrugated paperboard sheet having a multi-layer structure made up of a liner, a corrugated medium and a liner

The double cutter 310 has two cutters consisting of an upper cutter 312 and a lower cutter 314, and is disposed downstream of the slitter-scorer unit 1. A corrugated paperboard sheet DS scored and slit by the slitter-scorer unit 1 is dividedly led to the upper cutter 312 for a first process and the lower cutter 314 for a second process by the guide unit 308. Specifically, a corrugated paperboard sheet DS is slit into at least two portions (DS1, DS2 in FIG. 17) in a feed direction of the corrugated paperboard sheet DS by the slitters 4 of the slitter-scorer unit 1 (i.e., divided into right and left portions with respect to the feed direction).

The corrugated paperboard sheet portion DS1 is cut by a pair of cutter cylinders 312a, 312b of the upper cutter 312, and the corrugated paperboard sheet portion DS2 is cut by a pair of cutter cylinders 314a, 314b of the lower cutter 314. Each of the corrugated paperboard sheet portions DS1, DS2 may be different from each other in size and configuration.

Each of the two divided corrugated paperboard sheet portions DS1, DS2 may have one or more slits formed by the slitters 4. In this case, the two divided corrugated paperboard sheet portions DS1, DS2 having one or more slits are cut by the upper and lower cutters 312, 314, respectively.

The slitter-scorer apparatus according to the second embodiment for use in the above corrugator dry end 300 will be specifically described below.

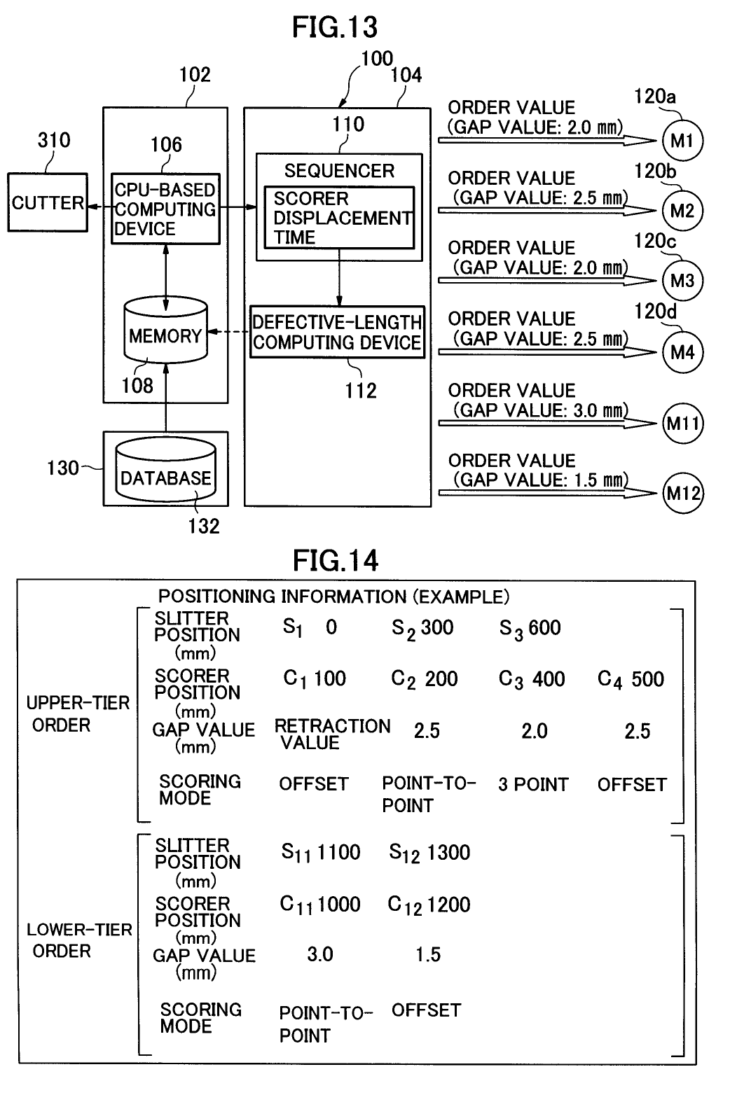

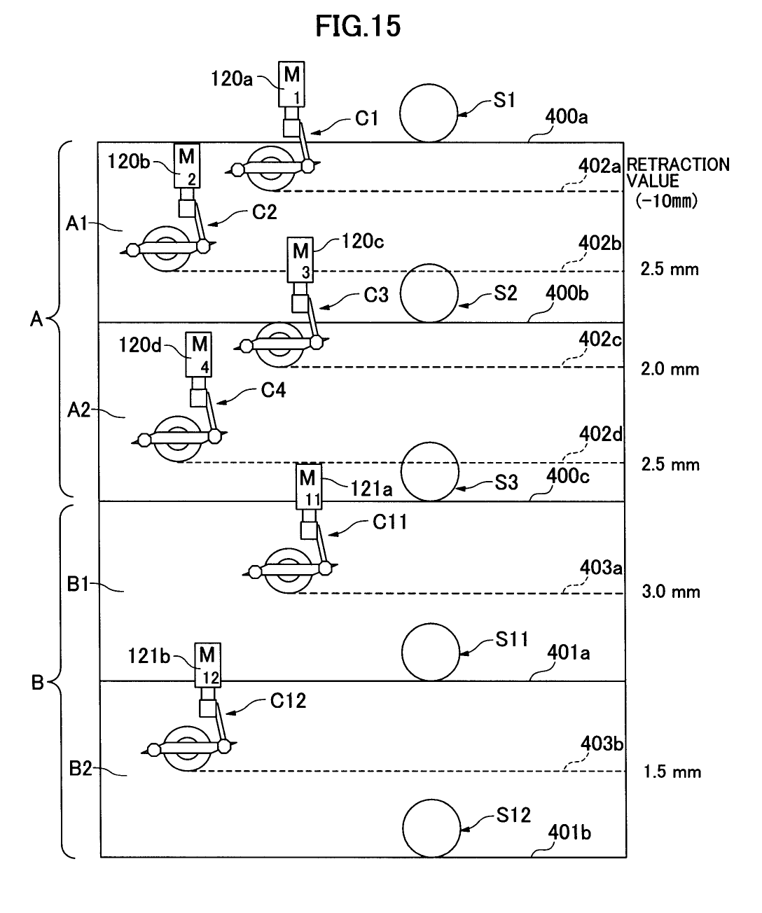

With reference to FIGS. 13 to 15, a configuration of a control system of the slitter-scorer apparatus according to the first embodiment will be firstly described. FIG. 13 is a block diagram showing the control system of the slitter-scorer apparatus according to the second embodiment. FIG. 14 illustrates one example of data to be imported into the control system of the slitter-scorer apparatus according to the second embodiment, and FIG. 15 is a conceptual explanatory diagram showing a corrugated paperboard sheet to be scored by the slitter-scorer apparatus according to the second embodiment. In the following description, an element or component equivalent to or corresponding to that in the first embodiment is defined by a common reference numeral or code.

As shown in FIG. 13, the control system 100 primarily comprises a management section 102 and a slitter-scorer control section 104. The management section 102 includes a CPU-based computing device 106 and a memory (storage device) 108. The slitter-scorer control section 104 primarily includes a sequencer 110 and a defective-length computing device 112.

For example, order information as shown in FIG. 9 is imported from a database 132 of a computer 130 placed in an office outside a plant, to the memory 108. The order information includes production order data which orders a slit position (S1, S2, S3) to be slit in a corrugated paperboard sheet DS by each of the slitters 4, a scoring pressure of each of the scorers 2 and a type of score line, based on any one or a combination of two or more of a flute and a paper quality of the corrugated paperboard sheet, and an area and a quality of a print to be applied to a corrugated paperboard sheet product in a carton forming process, and other production order data including information about the carton forming process under management. In the second embodiment, the management section 102 is operable to receive the production order data from the external computer having the database 132 and adjust a scoring operation while additionally taking account of conditions (print, etc) of a final product to be produced through the subsequent carton forming process. The management section 102 utilizes the external computer 103 in the above manner to allow the slitter-scorer control section 104, the management section 102 and the external computer 130 to share a plurality of rolls so as to achieve a function of forming plural types of score lines in one lot effectively and accurately, which was conventionally unachievable.

In FIG. 14, data (upper-tier order) about a corrugated paperboard sheet portion DS1 to be fed to the upper cutter 312 (see FIG. 17) (i.e., data about the first process), and data (lower-tier order) about a corrugated paperboard sheet portion DS2 to be fed to the lower cutter 314 (see FIG. 17) (i.e., data about the second process) are specified.

For example, as for the corrugated paperboard sheet portion DS1 to be fed to the upper cutter 312 (see FIG. 17), respective crosswise positions of the three slitters S1, S2, S3 of the slitter-scorer unit 1 are specified by a numerical value on millimeter scale, and respective crosswise positions of the four scorers C1, C2, C3, C4 of the slitter-scorer unit 1 are specified by a numerical value on millimeter scale. Further, as for the corrugated paperboard sheet portion DS2 to be fed to the lower cutter 314 (see FIG. 17), respective crosswise positions of two slitters S11, S12 of the slitter-scorer unit 1 are specified by a numerical value on millimeter scale, and respective crosswise positions of two scorers C11, C12 of the slitter-scorer unit 1 are specified by a numerical value on millimeter scale.

Further, as for the corrugated paperboard sheet portion DS1 to be fed to the upper cutter 312, respective inter-roll gap values (or scoring displacement amounts) of the four scorers C1, C2, C3, C4 are specified. As for the corrugated paperboard sheet portion DS2 to be fed to the lower cutter 314, respective inter-roll gap values (or scoring displacement amounts) of the two scorers C11, C12 are specified.

In the following description, a position where the upper scoring roll 10 is initially brought into contact with the corrugated paperboard sheet DS when it is displaced downwardly from the unloaded position in FIG. 5(a), 5(b), 6(a) or 7(a) will be referred to as “lowermost position of the upper scoring roll”, a position where the lower scoring roll 12 is in contact with the lower surface of the corrugated paperboard sheet DS will be referred to as “uppermost position of the lower scoring roll”. In the second embodiment, the inter-roll gap value (hereinafter referred to simply as “gap value”) means a numerical value representing a gap between the upper scoring roll 10 and the lower scoring roll 12 in a state after the upper scoring roll 10 is displaced downwardly from the unloaded position to the loaded position. In the second embodiment, the scoring displacement amount means an amount (distance) by which the upper scoring roll 10 is to be displaced, from a state when the upper scoring roll 10 is in the lowermost position and the lower scoring roll 12 is in the uppermost position. For example, a scoring displacement amount is set to obtain a given gap value, or a gap value is set to obtain a given scoring displacement amount.

In the example illustrated in FIG. 14, as for the corrugated paperboard sheet portion DS2 to be fed to the lower cutter 314, the gap values of the scorer C11 and the scorer C12 are specified as 3.0 mm and 1.5 mm, respectively. Thus, in each of the scorers C11, C12, the upper scoring roll 10 will be displaced downwardly by a scoring displacement amount allowing the gap value to be set at 3.0 mm or 1.5 mm, so that the protrusions 10a, 12a of the upper and lower scoring rolls 10, 12 as shown in FIG. 5(a), 5(b) or 7(a) or the protrusions 10a, 12a, 12b of the upper and lower scoring rolls 10, 12 as shown in FIG. 6(a) will be pressed against the corrugated paperboard sheet DS to obtain a score line having the configuration as shown in FIG. 5(c), FIG. 7(b) or FIG. 6(b).

Further, as for the corrugated paperboard sheet portion DST to be fed to the upper cutter 312, the gap value of each of the scorers C2, C4 is specified as 2.5 mm. Thus, in each of the scorers C2, C4, the upper scoring roll 10 will be displaced downwardly by a scoring displacement amount allowing the gap value to be set at 2.5 mm, so that the protrusions 10a, 12a of the upper and lower scoring rolls 10, 12 as shown in FIG. 5(a), 5(b) or 7(a) or the protrusions 10a, 12a, 12b of the upper and lower scoring rolls 10, 12 as shown in FIG. 6(a) will be pressed against the corrugated paperboard sheet DS to obtain a score line having the configuration as shown in FIG. 5(c), FIG. 7(b) or FIG. 6(b).

The data for each of the slitters and the scorers as shown in FIG. 14 is stored in the memory 108 of the management section 102, and the CPU-based computing device 106 is operable to provide the data as shown in FIG. 14 to the sequencer 110 of the slitter-scorer control section 104, as an order Then, the sequencer 110 is operable, based on the order, to send the order values to respective servomotors (not shown) of the slitters S1, S2, S3, S11, S12 and respective servomotors 120a, 120b, 120c, 120d, 121a, 121b (M1, M2, M3, M4, M11, M12) of the scorers C1, C2, C3, C4, C11, C12 as shown in FIGS. 13 and 15, so as to control each of the servomotors. Through the control, each of the slitters and the scorers is positioned in the crosswise direction, and each of the scorers is displaced downwardly, according to the order values as shown in FIG. 14, so that a slit line and a score line are formed, as shown in FIG. 15.

As the scoring displacement amount of each of the scorers C1, C2, C3, C4, C11, C12 as shown in FIG. 14, a retraction value may be entered. For example, when the retraction value is set at 10 mm, the upper scoring roll 10 will be displaced upwardly from the lowermost position to preclude a scoring operation.

In FIG. 15, the reference codes 400a, 400b, 400c, 401a, 401b indicate respective slit lines formed by the slitters S1, S2, S3, S11, S12 and the reference codes 402a, 402b, 402c, 402d, 403a, 403b indicate respective score lines formed by the scorers C1, C2, C3, C4, C11, C12.

In FIG. 15, the corrugated paperboard sheet DS is divided along the slit line 400c formed by the slitter S3, into a corrugated paperboard sheet portion A formed based on the upper-tier order, and a corrugated paperboard sheet portion B formed based on the lower-tier order.

In this example, in order to form the corrugated paperboard sheet portion A, the slitters S1 is operable to cut off an unnecessary edge portion in an upper-half of the corrugated paperboard sheet DS. Further, the slitter S2 is operable to divide the remaining upper-half into two sub-portions (two corrugated paperboard sheet products), and the slitter S3 is operable to form a slit line for allowing the remaining upper-half to be separated from the corrugated paperboard sheet portion B. In order to form the corrugated paperboard sheet portion B, the slitters S12 is operable to cut off an unnecessary edge portion in a lower-half of the corrugated paperboard sheet DS. Further, the slitter S11 is operable to divide the remaining lower-half into two sub-portions, and the slitter S3 is operable to form a slit line for allowing the remaining lower-half to be separated from the corrugated paperboard sheet portion A.

The two corrugated paperboard sheet sub-portions A1, A2 are fed to the upper cutter 312 (see FIG. 17) and simultaneously cut into a plurality pieces. The two corrugated paperboard sheet sub-portions B1, B2 are fed to the lower cutter 314 (see FIG. 17) and simultaneously cut into a plurality pieces.

In the first and second embodiments, a single corrugated paperboard sheet product may be produced by cutting off only an unnecessary edge portion using the two slitters 4 (S1 and S3 in the first embodiment or S1 and S12 in the second embodiment).

In the second embodiment, each of the scorers C1, C2, C3, C4, C11, C12 illustrated in FIG. 15 is designed to be used in the pint-to-point mode as shown in FIG. 5(a) or 5(b). In this case, in each of the scorers C3, C12 having a relatively large scoring displacement amount (the gap value is set at 2.0 mm or 1.5 mm as shown in FIG. 15, and thereby the scoring displacement amount is relatively large), a scoring operation is performed under a relatively high scoring pressure, whereas, in each of the scorers C2, C4, C12 having a relatively small scoring displacement amount, a scoring operation is performed under a relatively low scoring pressure.

As above, the gap values (or scoring displacement amounts) of the scorers C1, C2, C3, C4, C11, C12 can be set individually. For example, in the above case, a score line formed in the corrugated paperboard sheet DS by each of the scorers C1, C3, C11 having a relatively high scoring pressure can have a relatively high foldability, and a score line formed in the corrugated paperboard sheet DS by each of the scorers C2, C4, C12 having a relatively low scoring pressure can have a relatively low foldability. This makes it possible to specify a sequence of folding the corrugated paperboard sheet DS, in the order of a score line formed under a relatively high scoring pressure to a score line formed under a relatively low scoring pressure.

When the scoring pressure is lowered, a depth and size of a depression of a score line are reduced. Thus, even if a solid print is formed on the score line, deterioration in appearance (e.g., fading) of the print can be avoided. In other words, the scoring pressure for a score line which passes through a printing area can be lowered to obtain an excellent printing result.

In this manner, the gap values (or scoring displacement amounts) of the scorers C1, C2, C3, C4, C11, C12 are set (controlled) individually, depending on a desired depth and size of each of a plurality of score lines to be formed through a scoring operation, so that all the score lines can be adequately formed through a single-step scoring process.

Alternatively, among the scorers C1, C2, C3, C4, C11, C12 illustrated in FIG. 15, the scorers C1, C3, C11 may be designed to be used in the offset mode as shown in FIG. 7(a), and the scorer C2, C4, C12 may be designed to be used in the point-to-point mode as shown in FIG. 5(a) or 5(b). As shown in FIG. 7(a) (right and left figures), in the offset mode, the upper scoring roll 10 has to be displaced closer to the lower scoring roll 12 to obtain a given deformation amount, as compared with the point-to-point mode. In the second embodiment, the gap values (or scoring displacement amounts) of the scorers C1, C2, C3, C4, C11, C12 can be set individually, and therefore the gap values (or scoring displacement amounts) for the pint-to-point mode and the offset mode can be set individually to adequately perform respective scoring operations in the pint-to-point and offset modes. That is, the gap values (or scoring displacement amounts) of the scorers C1, C2, C3, C4, C11, C12 are specified depending on a required configuration (FIG. 5(c), FIG. 6(b), FIG. 7(c)) of each of a plurality of score lines, so that all the score lines can be adequately formed through a single-step scoring process. Further, relative offset positions and an offset distance between the protrusion 10a of the upper scoring roll 10 and the protrusion 12a of the lower scoring roll 12 can also be set individually on a scorer-by-scorer basis.

In the slitter-scorer control section 104, the sequencer 110 is operable to compute respective scorer displacement times of the scorers C1, C2, C3, C4, C11, C12 and then compute a defective length based on the computed scorer displacement times. The defective length is stored in the memory 108 of the management section 102. Then, the CPU-based computing device 106 is operable to read the stored defective length, and control the double cutter 310 adapted to cut off each of the corrugated paperboard sheet portions DS1, DS2 into a plurality of pieces each having a given length, to cut off and remove a defective-length portion thereof based on the read defective length.

As above, in the second embodiment, the defective length is computed based on the respective scorer displacement times of the plurality of scorers. This makes it possible to more adequately cut off and remove a defective-length portion.

Further, in this control system 100, the management section 102 is connected to the slitter-scorer control section 104 to control the slitter-scorer unit 1. This makes it possible to effectively control the plurality of scorers through the use of the existing slitter-scorer control section 104.

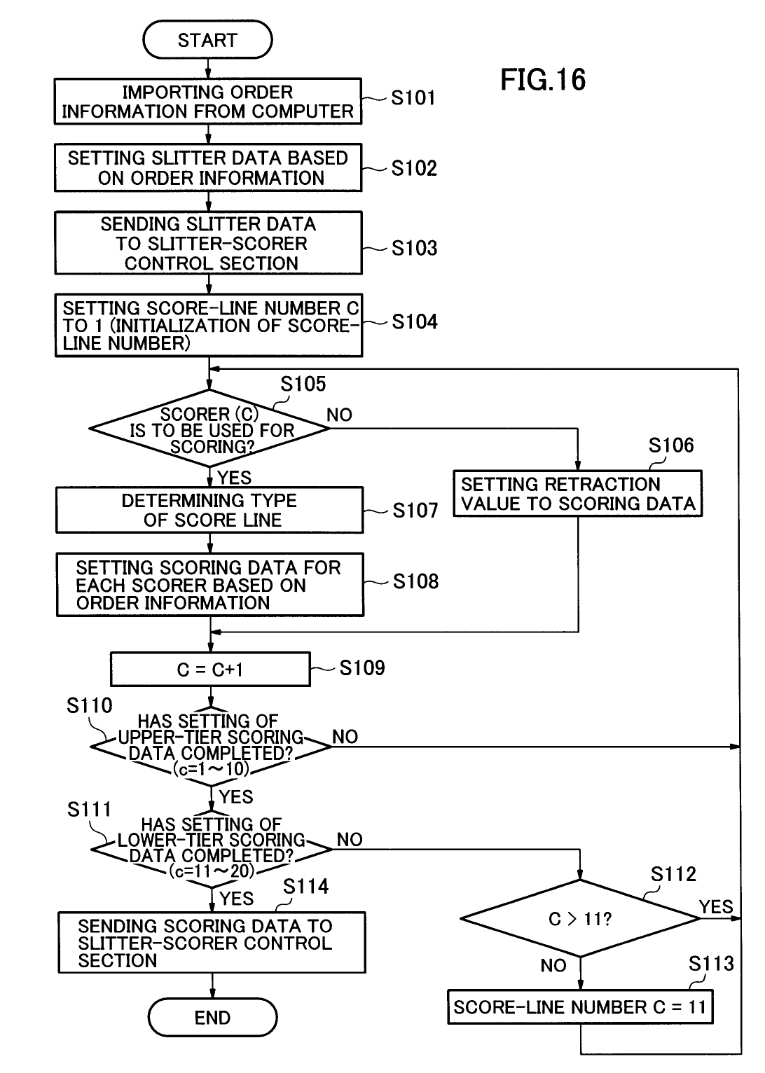

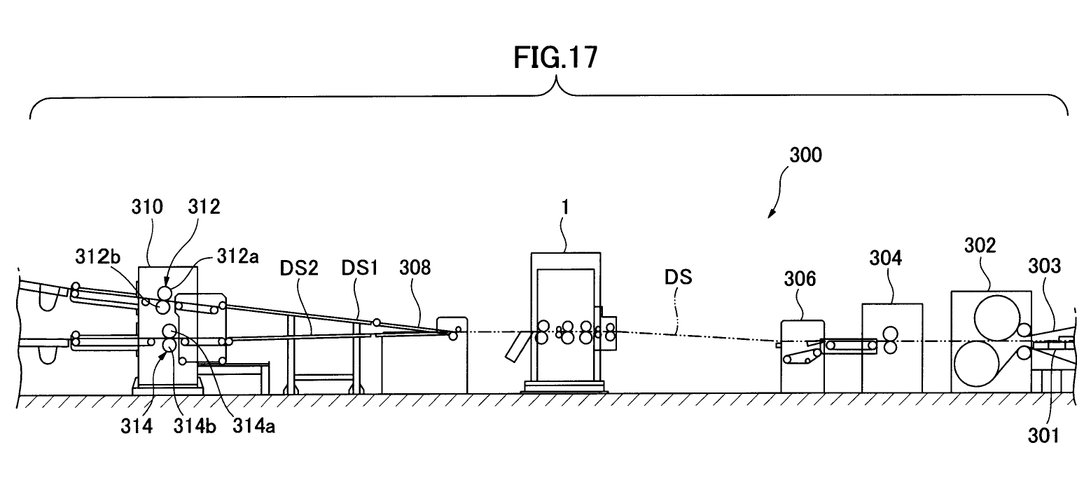

With reference to FIG. 16, details of a control of the CPU-based computing device 106 in the management section 102 will be described below. FIG. 16 is a flowchart showing a process of controlling the plurality of scorers by the CPU-based computing device 106 in the slitter-scorer apparatus according to the second embodiment. The following description will be made on an assumption that scoring displacement amounts of a plurality of scorers include three type consisting of a retraction value (for performing no scoring operation), a scoring type I (e.g., 2.30 mm) and a scoring type II (e.g., 1.70 mm).

In Step S101, order information is imported. Specifically, the management section 102 imports order input or production order data as shown in FIG. 14 from the database 132 of the external computer 130, and stores the imported data in the memory 108, as mentioned above. As shown in FIG. 14, the order input data or production order data (order information) may include a slitter crosswise position (mm), a scorer crosswise position (mm), a gap value (mm) and a scoring mode [a point-to-point mode (see FIG. 5(a) or 5(b)), a three-point mode (see FIG. 6(a)), an offset mode (see FIG. 7(a))].

In Step S102, slitter data (primarily, a crosswise position of each of the slitters 4) is set based on the data (order information) imported in Step S1. Then, in Step S103, the slitter data set in Step S102 is sent to the slitter-scorer unit 1. Specifically, information about respective crosswise positions of the slitters 4 is sent to the sequencer 110 of the slitter-scorer control section 104 to control an operation of each of the slitters 4.

In Step S104, a scoring number C is set to 1. This processing is intended to initialize the scoring number C.

In Step S105, it is determined whether one (C=n) of the scorers is to be used for scoring. If NO, the routine advances to Step S106. In Step S106, the retraction value is set as the scoring displacement amount. This processing in Step S166 is performed based on data as shown in FIG. 14. In the example illustrated in FIG. 14, the gap value of the scorer having a scoring number C1 is specified as the retraction value.

As for the corrugated paperboard sheet portion DS1 to be fed to the upper cutter 312 (see FIG. 17) (i.e., to be subjected to the first process), the scoring numbers C is assigned to each of the scorers using a sequential numerical number selected from 1 to 10. As for the corrugated paperboard sheet portion DS2 to be fed to the upper cutter 314 (see FIG. 17) (i.e., to be subjected to the second process), the scoring numbers C is assigned to each of the scorers using a sequential numerical number selected from 11 to 20.

If YES, i.e., the scorer (C=n) is to be used for scoring, the routine advances to Step S107. In Step S107, it is determined what the scoring type of the scorer (C=n) is. As mentioned above, in the second embodiment, the scoring type consists of the scoring type I (e.g., a scoring displace amount of 2.30 mm) and the scoring type II (e.g., a scoring displace amount of 1.70 mm). It is understood that the number of the scoring types may be three or more.

Then, the routine advances to Step S108. In Step S108, based on the order information imported in Step S101, scoring data, specifically a preset scoring displace amount (e.g., 2.30 mm) of the scoring type I or a preset scoring displace amount (e.g., 1.70 mm) of the scoring type II, is set for each of the scorers (having the respective scoring numbers C selected from 1 to 10 (upper-tier order) or the respective scoring numbers C selected from 11 to 20 (upper-tier order)).

Then, the routine advances to Step S109. In Step S109, the scoring number C is incremented to n+1. The scoring number C is incremented by one every time the processing of Step S109 is performed.

Then, in Step S110, it is determined whether setting of the scoring data in Step S108 is completed, i.e., the scoring number C reaches a given number required for scoring the corrugated paperboard sheet according to the upper-tire order. In the upper-tire order illustrated in FIG. 15, the required scoring number C is 4 (i.e., completion of the scoring operations of the scorers C1 to C4). Specifically, in Step S110, it is determined whether a current scoring number C is greater than a total number of the scorers (in the example illustrated in FIG. 14, four). If NO, the processings in Steps S105 to S109 will be performed while sequentially incrementing the scoring number C by one, only to the extent that the scoring number C does not become greater than the total number of the scorers. If it is determined that the setting is completed, the routine advances to Step S11. In Step S111, it is determined whether setting of the scoring data in Step S108 is completed, i.e., the scoring number C reaches a given number required for scoring the corrugated paperboard sheet according to the lower-tire order. In the lower-tire order illustrated in FIG. 15, the required scoring number C is 12 (i.e., completion of the scoring operations of the scorers C11, C12).

In the example illustrated in FIG. 15, when setting of the scoring data for the scorer C II (first setting of the scoring data according to the upper-tire order) is not completed although setting of the scoring data for the scorer C4 (last setting of the scoring data according to the upper-tire order) is completed, the scoring number is 4. In this case, in Step S112, based on determination on whether the scoring number is greater than 11, it can be determined that the setting of the scoring data according to the lower-tire order is not completed. If the determination in Step S112 is NO, the scoring number C is set to 11, and the processings of Steps S105 to S111 will be repeated to set the scoring data according to the lower-tire order.

Specifically, as for the lower-tire order illustrated in FIG. 15, it is determined whether a current scoring number C is greater than the largest scoring number assigned to the scorers (in the example illustrated in FIGS. 14, 12). If NO, the processings in Steps S105 to S111 will be performed while sequentially incrementing the scoring number C by one, only to the extent that the scoring number C does not become greater than the total number of the scorers.

Then, when both the settings according to the upper-tire and lower-tier orders are completed, i.e., both the determinations in Step S110 and Step S111 are YES, the routine advances to Step S114. In Step S114, the scoring displacement amounts obtained in Step S108 are sent to the sequencer 104 of the slitter-scorer control section 104, as scorer setting information.

Although the slitter-scorer apparatus according to the second embodiment is designed to form score lines in a direction perpendicular to flutes of a corrugated paperboard sheet, it may be used as a creaser for forming score lines in a direction parallel to flutes of a corrugated paperboard sheet.

The setting of the slitter data and scoring data for the corrugated paperboard sheet portion DS1 according to the upper-tire order, and the setting of the slitter data and scoring data for the corrugated paperboard sheet portion DS2 according to the lower-tire order, may be performed separately, or may be performed simultaneously or successively, based on the process illustrated in FIG. 11. In the process illustrated in FIG. 11, setting of the slitters can be performed using the processings of Steps S102, S103 and S108 in FIG. 16. Further, the setting of the slitter data and scoring data for the corrugated paperboard sheet portion DS1 according to the upper-tire order, and the setting of the slitter data and scoring data for the corrugated paperboard sheet portion DS2 according to the lower-tire order, may be achieved by successively performing the process illustrated in FIG. 11 for the upper-tire data and the lower-tire data. Further, the process illustrated in FIG. 16 may be applied to the first embodiment.

With reference to FIG. 17, the dry end 300 of the corrugator equipped with the slitter-scorer apparatus according to the second embodiment will be more specifically described. The corrugator dry end 300 includes the double facer 302 adapted to bond a liner to a single faced corrugated paperboard sheet so as to produce a double faced corrugated paperboard sheet. The double facer 302 comprises a heating plate 301 and a corrugating belt 303, wherein a single faced corrugated paperboard sheet and a liner are nipped between the heating plate 301 and the corrugating belt 303 and fed while being bonded together and dried.

The corrugated paperboard sheet DS from the double facer 302 is fed to the rotary shear 304. The rotary shear 304 is designed to cut the corrugated paperboard sheet DS from the double facer 302 at a position corresponding to an order change, over the entire width of corrugated paperboard sheet DS (i.e., in a direction perpendicular to the feed direction). The order change means a change in product specifications on cutting and/or scoring of a corrugated paperboard sheet.

The corrugated paperboard sheet DS from the rotary shear 304 is fed to a defective removing unit 306. This defective removing unit 306 is designed to remove a defective corrugated paperboard sheet to be formed in an initial stage of production of a corrugated paperboard sheet. In specifications of the corrugator dry end 300 illustrated in FIG. 17, a corrugated paperboard sheet is not cut over the overall width thereof by the rotary shear 304 during an order change. Thus, a portion of the corrugated paperboard sheet passing through the slitter-scorer apparatus during an order change operation thereof is removed as a defective portion by the defective removing unit 306. The corrugated paperboard sheet portions from the defective removing unit 206 are fed to a wet end of the corrugator.

The corrugated paperboard sheet DS from the defective removing unit 306 is fed to the slitter-scorer apparatus. The slitter-scorer apparatus is designed to form a slit line and a score line parallel to the feed direction of the corrugated paperboard sheet, as mentioned above. In the example illustrated in FIG. 17, one slitter-scorer apparatus (slitter-scorer unit 1) is provided in the feed line of the corrugator dry end 300. Alternatively, two slitter-scorer apparatuses may be provided therein.

In a conventional slitter-scorer apparatus, a positioning speed for each yoke is lower than a feed speed of a corrugated paperboard sheet. Thus, as disclosed in the aforementioned patent publications (JP 2002-036171A and U.S. Pat. No. 5,918,519), two slitter-scorer apparatuses are provided, wherein one of the slitter-scorer apparatuses is placed in a standby state after being prepared for dimensions in a next change in product specifications, while slitting/scoring a corrugated paperboard sheet by the other the slitter-scorer apparatus.

In contrast, the slitter-scorer apparatus according to the second embodiment has a relatively high positioning speed. Thus, even if the slitter-scorer apparatus is provided in a number of one, the single slitter-scorer apparatus can adequately cope with an order change. It is understood that the slitter-scorer apparatus according to the first embodiment may be provided in a plural number. An operation (order change operation) of the slitter-scorer apparatus during an order change is completed within a time period where a gap between upstream and downstream corrugated paperboard sheet portions formed by successively cut a corrugated paperboard sheet over the entire width thereof using the rotary shear 304 passes through the slitter-scorer apparatus.

The corrugated paperboard sheet DS from the slitter-scorer apparatus is fed to the double cutter 310 via the guide unit (lead-in table) 308. The guide unit 308 serves as a conveyer for guiding one (DS1) of the corrugated paperboard sheet portions DS1, DS2 slit and scored by the slitter-scorer apparatus (each having at least two corrugated paperboard sheet sub-portions) to the upper cutter, and guiding the other corrugated paperboard sheet portions DS2 to the lower cutter.

As mentioned above, the double cutter 310 has the pair of cutter cylinders 312a, 312b made up of the upper cutter 312, and the pair of cutter cylinders 314a, 314b made up of the lower cutter 314. The corrugated paperboard sheet portions DS1, DS2 separated from each other are cut by the upper cutter 312 and the lower cutter 314, respectively. The above double cutter 310 makes it possible to produce plural types of corrugated paperboard products different in length (products formed by cutting the corrugated paperboard sheet portion DS1, and products formed by cutting the corrugated paperboard sheet portion DS2).

The corrugated paperboard sheet products from the double cutter 310 are stacked by a seat stacker.

Although the present invention has been explained with reference to specific, preferred embodiments, one of ordinary skill in the art will recognize that modifications and improvements can be made while remaining within the scope and spirit of the present invention. The scope of the present invention is determined solely by appended claims.

What is claimed is:

1. A slitter-scorer apparatus provided in a feed line of a corrugated paperboard sheet, in a dry end of a corrugator machine, comprising:
a slitter for slitting the corrugated paperboard sheet along a feed direction of the corrugated paperboard sheet;
a plurality of scorers for scoring the corrugated paperboard sheet along the feed direction, each of the scorers being adapted to be displaced in a crosswise direction perpendicular to the feed direction and to a given position of the corrugated paperboard sheet, and made up of a pair of upper and lower segments at least one of which is adapted to be displaced in a vertical direction to adjust a gap therebetween, during the scoring;
scorer control means for controlling the crosswise and/or vertical displacements of each of the scorers; and
displacement-amount control means, based on given order information, for providing information to the scorer control means in such a manner as to allow the scorer control means to control respective vertical displacement amounts of the scorers individually on a scorer-by-scorer basis during the scoring.

2. The slitter-scorer apparatus according to claim 1, wherein the displacement amount control means is operable to control the respective vertical displacement amounts of the scorers individually in such a manner as to allow respective scoring pressures of the scorers to become different from each other.

3. The slitter-scorer apparatus as defined in claim 2, wherein the displacement amount control means is operable to control the respective vertical displacement amounts of the scorers in such a manner that at least two or more of the scorers have different scoring pressures which allow respective score lines formed by the at least two or more scorers to be different in foldability.

4. The slitter-scorer apparatus as defined in claim 2, wherein the displacement amount control means is operable to control the respective vertical displacement amounts of the scorers in such a manner that any one or more of the scorers each arranged to form a score line in a printing area of the corrugated paperboard sheet have a scoring pressure set to be less than that for the remaining scorers so as to prevent the score line from causing print fading.

5. The slitter-scorer apparatus as defined in claim 2, wherein,
the scorers include at least two scorers each having a pair of protrusions which are arranged to protrude respectively in a downward direction and in an upward direction, and adapted to be located in opposed relation to each other at a common position; and
the displacement amount control means is operable to control respective vertical displacement amounts of the at least two scorers in such a manner that respective scoring pressures to be generates by the at least two pairs of protrusions of the at least two scorers become different from each other.

6. The slitter-scorer apparatus as defined in claim 1, wherein the displacement amount control means is operable to controllably allow the respective vertical displacement amounts of the scorers to become different from each other, depending on a configuration of a score line to be formed by each of the scorers.

7. The slitter-scorer apparatus as defined in claim 6, wherein the displacement amount control means is operable to control the respective vertical displacement amounts of the scorers in such a manner that respective score lines formed by at least two or more of the scorers have configurations different in folding direction and/or size.

8. The slitter-scorer apparatus as defined in claim 7, wherein the pair of upper and lower segments in at least one of the scorers have respective ones of a pair of protrusions which are arranged to protrude respectively in a downward direction and in an upward direction, and adapted to be positionally adjusted in the crosswise direction so as to be located in opposed relation to each other, at a common position, and the pair of upper and lower segments in at least one of the remaining scorers have respective ones of a pair of protrusions which are arranged to protrude respectively in the downward direction and in the upward direction, and adapted to be positionally adjusted in the crosswise direction in such a manner that the protrusion of one of the upper and lower segments and a planar portion of the other segment are located in opposed relation to each other at mutually offset positions, wherein at least one of the configurations of foldable score lines is obtained by the scoring based on the pair of protrusions located at the mutually offset positions.

9. The slitter-scorer apparatus as defined in claim 8, wherein the displacement amount control means is operable to control respective vertical displacement amounts of the at least two scorers in such a manner that the vertical displacement amount of the at least one scorer having the pair of protrusions located in opposed relation to each other at the common position becomes greater than that of the at least one scorer having the pair of protrusions located at the mutually offset positions, whereby a concave portion defining a folding direction is formed in each of front and rear surfaces of the corrugated paperboard sheet through the scoring based on the pair of protrusions located in the opposed relation to each other at the common position, and a bent portion is formed in the corrugated paperboard sheet through the scoring based on the pair of protrusions located at the mutually offset positions.

10. The slitter-scorer apparatus as defined in claim 8, wherein the displacement amount control means is operable to control the respective vertical displacement amounts of the at least two scorers in such a manner that the vertical displacement amount of the at least one scorer having the pair of protrusions located in opposed relation to each other at the common position becomes greater than that of the at least one scorer having the pair of protrusions located at the mutually offset positions, whereby a concave portion is formed in each of front and rear surfaces of the corrugated paperboard sheet through the scoring based on the pair of protrusions located in opposed relation to each other at the common position, and a bent portion is formed in the corrugated paperboard sheet through the scoring based on the pair of protrusions located at the mutually offset positions, in such a manner that a size of the bent portion becomes greater than that of the concave portion.

11. The slitter-scorer apparatus as defined in claim 7, wherein the pair of upper and lower segments in at least one of the scorers have a protrusion and a recess, respectively, wherein a foldable score line is formed in a configuration which protrudes upwardly or downwardly, by the protrusion and the recess.

12. The slitter-scorer apparatus as defined in claim 1, wherein:
the displacement amount control means is operable to compute the respective vertical displacement amount of the scorers using a computing device; and
each of the scorers is adapted to be displaced based on a servomotor according to a signal from the computing device.

13. The slitter-scorer apparatus as defined in claim 1, which comprises a management section operable, based on the given order information, to provide to the scorer control means information about computational processing for the scoring of the corrugated paperboard sheet, wherein:
the scorer control means includes computing means operable to compute a defective length from a longest one of respective displacement times of the scorers in the vertical direction and the crosswise direction; and
the management section includes defective-length cutting means operable to instruct a cutter adapted to cut the corrugated paperboard sheet into a plurality of pieces each having a given length, to cut off and remove a defective-length portion of the corrugated paperboard sheet based on the computed defective length.

14. The slitter-scorer apparatus as defined in claim 1, wherein:
the given order information includes production order data which orders a scoring pressure of each of the scorers and a type of score line, based on any one or a combination of two or more of a flute and a paper quality of the corrugated paperboard sheet, and an area and a quality of a print to be applied to a corrugated paperboard sheet product in a carton forming process, and
the displacement amount control means is operable to receive the production order data from an external computer connected to the management section, and control the respective vertical displacement amounts of the scorers based on the received production order data.

15. The slitter-scorer apparatus as defined in claim 1, wherein the feed line of the corrugated paperboard sheet in the dry end of the corrugator machine is provided with a cutter for cutting the corrugated paperboard sheet along the crosswise direction, the cutter consisting of a single cutter which is provided in a number of one to the feed line, wherein the corrugated paperboard sheet after being slit and scored by the slitter and the scorers is entirely fed to the single cutter.

16. The slitter-scorer apparatus as defined in claim 15, wherein:
the slitter is adapted to slit the corrugated paperboard sheet along the feed direction so as to form at least two corrugated paperboard sheet portions arranged in the crosswise direction;
each of the scorers is adapted to score the at least two corrugated paperboard sheet portions; and
the single cutter is adapted to simultaneously cut the at least two corrugated paperboard sheet portions after being scored.

17. The slitter-scorer apparatus as defined in claim 1, wherein:
the slitter is adapted to slit the corrugated paperboard sheet along the feed direction so as to form at least two corrugated paperboard sheet portions arranged in the crosswise direction;
each of the scorers is adapted to score the at least two corrugated paperboard sheet portions; and
the feed line of the corrugated paperboard sheet in the dry end of the corrugator machine is provided with a cutter for cutting the corrugated paperboard sheet along the crosswise direction, the cutter comprising an upper cutter and a lower cutter which are disposed in a two-tiered arrangement with respect to the feed line, wherein the at least two corrugated paperboard sheet portions after being slit and scored by the slitter and the scorers are fed to the upper cutter and the lower cutter, separately.

18. The slitter-scorer apparatus as defined in claim 17, wherein:
the slitter is adapted to slit the corrugated paperboard sheet in such a manner that each of the at least two corrugated paperboard sheet portions has a same or different length in the crosswise direction; and
each of the upper and lower cutters is adapted to cut a corresponding one or more of the at least two corrugated paperboard sheet portions into pieces each having a same or different length in the feed direction.

19. A scorer apparatus provided in a feed line of a corrugated paperboard sheet, in a dry end of a corrugator machine, comprising:
a plurality of scorers for scoring the corrugated paperboard sheet along a feed direction of the corrugated paperboard sheet, each of the scorers being adapted to be displaced in a crosswise direction perpendicular to the feed direction and to a given position of the corrugated paperboard sheet, and made up of a pair of upper and lower segments at least one of which is adapted to be displaced in a vertical direction to adjust a gap therebetween, during the scoring;
scorer control means operable to control the crosswise and/or vertical displacements of each of the scorers; and
a management section operable, based on the given order information, to provide to the scorer control means information about computational processing for the scoring of the corrugated paperboard sheet, the management section including displacement amount control means operable to provide information to the scorer control means as a part of the information about computational processing for the scoring, in such a manner as to allow the scorer control means to control respective vertical displacement amounts of the scorers individually on a scorer-by-scorer basis during the scoring.

20. A corrugator machine for a corrugated paperboard sheet, comprising:
a double facer;
a slitter for slitting a corrugated paperboard sheet fed from the double facer, along a feed direction of the corrugated paperboard sheet,
a plurality of scorers for scoring the corrugated paperboard sheet along the feed direction, each of the scorers being adapted to be displaced in a crosswise direction perpendicular to the feed direction and to a given position of the corrugated paperboard sheet, and made up of a pair of upper and lower segments at least one of which is adapted to be displaced in a vertical direction to adjust a gap therebetween, during the scoring;
scorer control means operable to control the crosswise and/or vertical displacements of each of the scorers;
displacement-amount control means operable, based on given order information, to provide information to the scorer control means in such a manner as to allow the scorer control means to control respective vertical displacement amounts of the scorers individually on a scorer-by-scorer basis during the scoring; and
a cutter for cutting the corrugated paperboard sheet fed from the slitter and the scorers, along the crosswise direction, the cutter consisting of a single cutter which is provided in a number of one to the feed line, or comprising an upper cutter and a lower cutter which are disposed in a two-tiered arrangement with respect to the feed line.
